(19) United States
(12) Patent Application Publication
(10) Pub. No.: US 2009/0073059 A1
(43) Pub. Date: Mar. 19, 2009

(54) Antenna and electrical apparatus including the same

(75) Inventor: Morihiko Ikegaya, Kasumigaura (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 12/219,849

(22) Filed: Jul. 29, 2008

(30) Foreign Application Priority Data
Jul. 31, 2007 (JP) 2007-199711

(51) Int. Cl. H01Q 1/38; H01Q 1/24

(52) U.S. Cl. 343/702; 343/700 MS

(57) ABSTRACT

An antenna includes antenna elements, an electric power feeding portion for supplying an electric power to each of the antenna elements, a short-circuit element for antenna matching electrically connected to the electric power feeding portion, and a ground connected to the short-circuit element. The antenna is built in a chassis made of a metal, and the chassis made of a metal and the ground are electrically connected to each other.

The present application is based on Japanese patent application No. 2007-199711 filed on Jul. 31, 2007, the entire contents of which are incorporated herein by reference.

### BACKGROUND OF THE INVENTION

1. Field of the Invention

The present invention relates to an antenna which is built in a chassis of a mobile terminal or an appliance and through/at which an electric wave of a digital broadcasting is transmitted/received, and an electrical apparatus including the antenna, and more particularly to a structure of an antenna for realizing measures taken to cope with an influence of electrical noises existing in a chassis in which the antenna is built, and a method of building the antenna in a chassis.

2. Description of the Related Art

In recent years, a digital broadcasting system starts to come into wide use by being substituted for an analog broadcasting system including terrestrial television broadcastings. Moreover, the switching from the analog broadcastings to the digital broadcastings has been planned on a global basis. Also, recently, antennas for receiving thereat the electric waves of the digital broadcastings also have come to be mounted to various appliances (hereinafter collectively referred to as “electrical apparatuses” for short) as well as mobile computers (hereinafter collectively referred to as “mobile terminals” for short) including a mobile phone, a PDA and a notebook-size PC.

At the present time, almost the antennas which are mounted to the mobile terminals and electrical apparatuses described above are typified by a rod antenna, made of a conductor, having a rod-like structure, and a large-size linear antenna. In this case, the rod antenna is mounted outside a main body of the mobile terminal or the electrical apparatus, and is made to extend outward from the main body thereof to be used. Also, the large-size linear antenna utilizes either a cable of earphones connected to a headphone connector provided in the main body of the mobile terminal or the electrical apparatus, or a dedicated cable connected to an antenna connection terminal of the main body thereof.

In the case of the antenna as described above, during the movement or reinstallation of the mobile terminal or the electrical apparatus, a user is usually associated with the botherations such as a method of distributing a cable or the like, a failure of the antenna due to repetition of attachment and detachment of a connector or an unanticipated trouble, and a restriction on the degree of freedom in a method of installing the mobile terminal or the electrical apparatus.

The techniques described in Japanese Patent No. 3,830,358 and Japanese Patent Laid-Open No. 2003-152430 and devised in order to solve the problems described above are known as typical known examples in each of which an antenna itself is built in a chassis of a mobile terminal or an electrical apparatus. With these known examples, it is possible to provide the inexpensive antenna which is readily built in the chassis of the mobile terminal or the electrical apparatus, and which is excellent in the general versatility. However, when an S/N ratio which is defined by a ratio of a strength of a received signal received at the antenna, to a strength of an electrical noises existing in the circumference of the mobile terminal or the electrical apparatus, or in the chassis thereof is poor, especially in the reception operation of the system for transmitting/receiving the digital electric wave, it is impossible to meet a tolerance, in a normal operation, for a received signal processing executed in a tuner for transmission/reception (module). As a result, the received signal can not be regenerated in the form of an image and a sound in some cases. For this reason, when the antenna is built in the chassis, it is absolutely imperative to take measures to cope with the electrical noises existing in the chassispecially, readily exerting an influence on the received signal. However, with the antenna structure and the method of building the antenna in the chassis described in the known examples described above, the measures are not sufficiently taken to cope with the electrical noises. Actually, many generation sources of the electrical noises exist in the chassis of the mobile terminal or the electrical apparatus. Thus, in the case where the antenna through/at which the digital signals transmitted/received is built in the chassis, it is necessary to prevent the antenna concerned from being influenced by the electrical noises generated from the noise sources existing in the chassis.

As has been described above, although with the conventional technique, the antenna is readily built in the chassis of the mobile terminal or the electrical apparatus, the measures are not sufficiently taken to cope with the electrical noises existing in the chassis which is necessary, especially, during the reception of the transmission and reception of the digital signal electric wave. For this reason, there is the possibility that the antenna can not be utilized as an antenna, for reception, compatible with the digital signal electric wave including the electric wave of the digital broadcasting.

In addition, it may be said that taking measures to cope with the electrical noises existing in the chassis by the mobile terminal or electrical apparatus itself is the best measures. However, the possibility that these measures thus taken causes rise in fabricating cost of the mobile terminal or electrical apparatus itself is high. Therefore, it is desirable to improve the measures taken to cope with the electrical noises becoming the problem with the antenna as one component of the mobile terminal or the electrical apparatus by utilizing a simpler and more general method.

### SUMMARY OF THE INVENTION

(1) According to one embodiment of the invention, an antenna, comprising: antenna elements; an electric power feeding portion for supplying an electric power to each of the antenna elements; a short-circuit element for antenna matching electrically connected to the electric power feeding portion; and a ground connected to the short-circuit element, wherein the antenna is built in a chassis made of a metal, and the chassis made of a metal and the ground are electrically connected to each other.

(2) According to another embodiment of the invention, an antenna built in a chassis of a mobile terminal or an electrical apparatus, comprising: a single or a plurality of antenna elements; and a ground, wherein the ground is electrically connected to a metallic (conductor) portion of the chassis.

According to still another embodiment of the invention, an antenna built in a chassis of a mobile terminal or an electrical apparatus, comprising: a plurality of antenna elements; a antenna element portion having a loop structure; and a ground, wherein the ground is electrically connected to a metallic (conductor) portion of the chassis.

In the above embodiment (1), the following modifications and changes can be made.

When the antenna is built in a chassis of a mobile terminal or an electrical apparatus, a ground of the antenna is provided to face a metallic (conductor) part(s) so as to be close the metallic (conductor) part(s) within the chassis.

In the above embodiment (2), the following modifications and changes can be made.

At least one slot structure is provided between the single or plurality of antenna elements and the ground.

In the above embodiment (1), the following modifications and changes can be made.

One slot structure and one loop structure are provided between the plurality of antenna elements and the ground of the antenna with a feeding point as a boundary, and the slot structure is larger in size than the loop structure.

In the above embodiment (6), the following modifications and changes can be made.

When the antenna is built in the chassis of the mobile terminal or the electrical apparatus, the loop structure of the antenna is installed in a position located at a distance away from a metallic (conductor) part(s).

In the above embodiment (5), the following modifications and changes can be made.

When the plurality of antenna elements are provided in the antenna, at least one antenna element is provided between one antenna element and the ground.

In the above embodiment (4), the following modifications and changes can be made.

The ground of the antenna and at least one antenna element are disposed so as to face each other.

In the above embodiment (7), the following modifications and changes can be made.

The loop structure included in the antenna does not include a portion of the ground facing the metallic (conductor) part(s) close thereto within the chassis.

In the above embodiment (4), the following modifications and changes can be made.

The ground of the antenna, and the metallic (conductor) part(s) of the chassis are not electrically connected to each other.

An electrical apparatus having the antenna according to above (4) built therein.

In the light of the foregoing, it is therefore an object of the present invention to provide an antenna which is capable of stably operating by taking measures to cope with electrical noises existing in a chassis having the antenna built therein, the antenna being built in a chassis of a mobile terminal or an electrical apparatus and transmitting/receiving a digital signal electric wave including an electric wave of a digital broadcasting, and a method of building the antenna in the chassis of the mobile terminal or the electrical apparatus, and an electrical apparatus including the antennas.

According to the antenna of the invention, when the antenna is built in the chassis of the mobile terminal or the electrical apparatus, it has the loop structure in the position located at a distance from away the metallic (conductor) parts close thereto due to a limit to the built-in space, which results in that the electrical noises invading the antenna can be made less because it is possible to keep the loop structure causing the invitation of the electrical noises far way from each of the transmission path and generation source of the electrical noises.

According to the antenna of the invention, when the antenna is built in the chassis of the mobile terminal or the electrical apparatus, it includes the ground to face the metallic (conductor) part(s) so as to be close to the metallic (conductor) part(s), and another antenna element between the antenna element and the ground. As a result, it is possible to keep the main element relating to the transmission/reception of the electric wave far away from the ground so as to maintain the radiation characteristics of the antenna. Moreover, the matching characteristics can also be enhanced with still another element disposed between each of these elements, and the ground.

When the antenna is built in the chassis of the mobile terminal or the electrical apparatus, the feeder cable used in the antenna of the invention is disposed in a direction of shortening the connection distance between the antenna and the transmission/reception tuner (module). As a result, it is possible to suppress an increase in transmission loss, and deterioration of the strengths of the transmission signal and the received signal. Moreover, it is possible to shorten the path length in which the feeder cable itself is influenced by the electrical noises.

The feeder cable used in the antenna of the invention is disposed so as to extend in the direction of not facing each of the antenna elements. As a result, no influence is exerted on the electric wave transmission/reception characteristics of each of the antenna elements, and moreover, the feeder cable is readily disposed when the antenna is built in the chassis of the mobile terminal or the electrical apparatus.

As a result of the foregoing, the invention offers the superior effects as will be described below.

(1) It is possible to realize the built-in antenna which is influenced by the less electrical noises.

(2) It is possible to realize the built-in antenna which is readily installed with the space saving.

### BRIEF DESCRIPTION OF THE DRAWINGS

The preferred embodiments according to the invention will be explained below referring to the drawings, wherein:

FIG. 1 is a perspective view showing an example of a mobile terminal or an electrical apparatus having an antenna built therein relating to the problems to be solved by the invention;

FIG. 2 is an exploded perspective view explaining an example of the mobile terminal or the electrical apparatus having the antenna built therein relating to the problems to be solved by the invention;

FIG. 3 is a front view explaining an example of the mobile terminal or the electrical apparatus having the antenna built therein relating to the problems to be solved by the invention;

FIG. 4 is a perspective view explaining an example of the mobile terminal or the electrical apparatus having the antenna built therein relating to the problems to be solved by the invention;

FIG. 5 is an exploded perspective view showing the antenna built in the mobile terminal or the electrical apparatus relating to the problems to be solved by the present invention;

FIG. 6 is a perspective view showing the antenna built in the mobile terminal or the electrical apparatus relating to the problems to be solved by the present invention;

FIGS. 7A and 7B are respectively perspective views each explaining the antenna built in the mobile terminal or the electrical apparatus relating to the problems to be solved by the present invention;

FIGS. 8A to 8C are respectively spectral graphs each explaining characteristics of the antenna built in the mobile terminal or the electrical apparatus relating to the problems to be solved by the present invention;

FIG. 9 is a perspective view explaining electrical noises existing in the mobile terminal or the electrical apparatus relating to the problems to be solved by the invention;

FIG. 10 is a perspective view explaining the electrical noises existing in the mobile terminal or the electrical apparatus relating to the problems to be solved by the invention;

FIG. 11 is a top plan view explaining a consideration relating to antenna design of the invention;

FIGS. 12A and 12B are respectively spectral graphs showing the effects offered based on the consideration relating to the antenna design of the invention;

FIGS. 13A to 13C are respectively perspective views showing examples of a structure of an antenna according to Embodiment 1 of the invention;

FIG. 14 is a spectral graph showing an example of characteristics of the antenna according to Embodiment 1 of the invention;

FIG. 15 is an exploded perspective view explaining a method of building the antenna according to Embodiment 1 of the invention in a chassis of a mobile terminal or an electrical apparatus;

FIGS. 16A and 16B are respectively perspective views explaining the method of building the antenna according to Embodiment 1 of the invention in the chassis of the mobile terminal or the electrical apparatus;

FIG. 17 is a spectral graph showing characteristics of the antenna according to Embodiment 1 of the invention;

FIG. 18 is a spectral graph showing characteristics of the antenna according to Embodiment 1 of the invention;

FIGS. 19A to 19C are respectively a perspective view explaining a measurement method with an electrical apparatus having the antenna built therein, and characteristic diagrams showing characteristics of the antenna according to Embodiment 1 of the invention;

FIGS. 20A and 20B are respectively spectral graphs showing characteristics of the antenna according to Embodiment 1 of the invention;

FIG. 21 is a perspective view showing a structure of an antenna according to Embodiment 2 of the invention;

FIG. 22 is an exploded view explaining a method of building the antenna according to Embodiment 2 of the invention in a chassis of a mobile terminal or an electrical apparatus;

FIGS. 23A and 23B are respectively perspective views explaining the method of building the antenna according to Embodiment 2 of the invention in the chassis of the mobile terminal or the electrical apparatus;

FIG. 24 is a spectral graph showing characteristics of the antenna according to Embodiment 2;

FIG. 25 is a perspective view showing a structure of an antenna according to Embodiment 3 of the invention;

FIG. 26 is an exploded perspective view explaining a method of building the antenna according to Embodiment 3 of the invention in a chassis of a mobile terminal or an electrical apparatus;

FIGS. 27A and 27B are respectively perspective views explaining the method of building the antenna according to Embodiment 3 of the invention in the chassis of the mobile terminal or the electrical apparatus;

FIG. 28 is a perspective view showing a structure of an antenna according to Embodiment 4 of the invention;

FIGS. 29A and 29B are respectively perspective views explaining a method of building the antenna according to Embodiment 4 of the invention in a chassis of a mobile terminal or an electrical apparatus;

FIG. 30 is a perspective view showing a structure of an antenna according to Embodiment 5 of the invention;

FIG. 31 is a perspective view showing a structure of an antenna according to Embodiment 6 of the invention;

FIG. 32 is an exploded view explaining a method of building the antenna according to Embodiment 6 of the invention in a chassis of a mobile terminal or an electrical apparatus;

FIG. 33 is a perspective view showing a structure of an antenna according to Embodiment 7 of the invention;

FIG. 34 is a partially exploded perspective view explaining a method of building the antenna according to Embodiment 7 of the invention in a chassis of a mobile terminal or an electrical apparatus;

FIG. 35 is a perspective view showing a structure of an antenna according to Embodiment 8 of the invention;

FIG. 36 is a perspective view showing a structure of an antenna according to Embodiment 9 of the invention;

FIG. 37 is a perspective view showing a structure of an antenna according to Embodiment 10 of the invention;

FIG. 38 is a perspective view showing a structure of an antenna according to Embodiment 11 of the invention;

FIGS. 39A and 39B are respectively a perspective view showing a structure of an antenna according to Embodiment 12 of the invention, and a partially enlarged view of a portion indicated by a dotted-line circle shown in FIG. 39A;

FIG. 40 is a perspective view showing a structure of an antenna according to Embodiment 13 of the invention;

FIG. 41 is a perspective view showing a structure of an antenna according to Embodiment 14 of the invention;

FIG. 42 is a perspective view showing a structure of an antenna according to Embodiment 15 of the invention;

FIG. 43 is a perspective view showing a structure of an antenna according to Embodiment 16 of the invention;

FIG. 44 is a perspective view showing a structure of an antenna according to Embodiment 17 of the invention;

FIG. 45 is a perspective view showing a structure of an antenna according to Embodiment 18 of the invention;

FIG. 46 is a perspective view showing a structure of an antenna according to Embodiment 19 of the invention;

FIG. 47 is a perspective view showing a structure of an antenna according to Embodiment 20 of the invention;

FIG. 48 is a perspective view showing a structure of an antenna according to Embodiment 21 of the invention;

FIG. 49 is a perspective view showing a structure of an antenna according to Embodiment 22 of the invention;

FIGS. 50A and 50B are respectively a perspective view showing a structure of an antenna according to Embodiment 23 of the invention, and a partially enlarged view of a tuning circuit shown in FIG. 50A;

FIGS. 51A and 51B are respectively perspective views each showing a structure of an antenna according to Embodiment 24 of the invention;

FIGS. 52A and 52B are respectively perspective views each showing a structure of an antenna according to Embodiment 25 of the invention;

FIGS. 53A to 53B are respectively perspective views each showing a structure of an antenna according to Embodiment 26 of the invention;

FIG. 54 is a perspective view showing a structure of an antenna according to Embodiment 27 of the invention;

FIG. 55 is a partially exploded perspective view explaining a method of building the antenna according to Embodiment 27 of the invention in a chassis of a mobile terminal or an electrical apparatus;

FIGS. 56A and 56B are respectively perspective views each showing a structure of an antenna according to Embodiment 28 of the invention;

FIGS. 57A and 57B are respectively perspective views each showing a structure of an antenna according to Embodiment 29 of the invention;

FIG. 58 is a perspective view showing a structure of an antenna according to Embodiment 30 of the invention; and

FIGS. 59A and 59B are respectively perspective views each showing a structure of an antenna according to Embodiment 31 of the invention.

### DETAILED DESCRIPTION OF THE PREFERRED EMBODIMENTS

An antenna of the invention realizes a structure of a built-in antenna which is free from an influence by electrical noises by using a structure in which transmission paths of the electrical noises transmitted through a metallic portion within a chassis to invade the antenna is greatly cut in consideration of generation sources of the electrical noises and the transmission paths of the electrical noises in the circumference of a position, where the antenna is built in, provided within a chassis of a mobile terminal or an electrical apparatus, and a method of building the antenna in the chassis of the mobile terminal or the electrical apparatus, and by using a structure in which the invasion of the electrical noises transmitted through a metallic portion within the chassis or propagated from the space into the antenna due to the electromagnetic induction is largely reduced.

The built-in position of the antenna means a narrow space, for the building-in of the antenna, which is provided either in a part of an LCD chassis for accommodating therein an LCD main body, or in a part of a keyboard chassis in the case of the mobile terminal, and means a space, for the building-in of the antenna, which is provided within a chassis in the case of the appliance (electrical apparatus).

The generation source of the electrical noises in the circumference of the built-in position means a device including an electrical circuit board mounted to the mobile terminal or the appliance, and an oscillation circuit provided in an image displaying apparatus such as an LCD.

In addition, the transmission path of the electrical noises in the circumference of the built-in position means a direction or a path length along which the electrical noises generated from the generation sources of the electrical noises are transmitted through the electrical circuit board mounted to the mobile terminal or the appliance, or the metallic portion of the image displaying apparatus such as the LCD, and the conductive portion installed in the chassis of the structure or the like for which the measures are taken to cope with the electric wave interference with an external apparatus (device) due to the image display apparatus.

It is noted that the generation sources and transmission paths of the electrical noises are determined in accordance with the measurement results of the strength of the electrical noises which is measured by using an electromagnetic probe or a reception antenna specially prepared after turn-ON of a power source of the mobile terminal or appliance having the antenna built therein.

In order to prevent the electrical noises from being transmitted through the conductive portion of the mobile terminal or the appliance to reach the antenna, thereby invading the antenna, the antenna itself has a ground portion so as to function as an antenna even when the conductor portion is not used as the ground portion.

When the conductive portion existing in the chassis of the mobile terminal or the appliance is used as the ground portion, the antenna of the invention uses another conductor portion other than the conductor portion incident to the apparatus having the generation sources of the electrical noises as the ground portion. Also, the ground portion concerned is fixed to the antenna by using conductive screws or the like, and a conductive tape or the like. Thus, the ground portion of the antenna itself and a connection portion with the ground portion concerned are made to agree with each other as a coupling portion.

Owing to the measures taken to cope with the electrical noises, the antenna of the invention can be installed close to the conductor portion incident to the LCD or the apparatus having the generation sources of the electrical noises such as the electrical circuit board.

Owing to the measures taken to cope with the electrical noises, the antenna of the invention can include a tuning circuit for controlling an operating frequency, and an electrical circuit, such as an amplifier, for performing loss correction for an electric wave reception sensitivity.

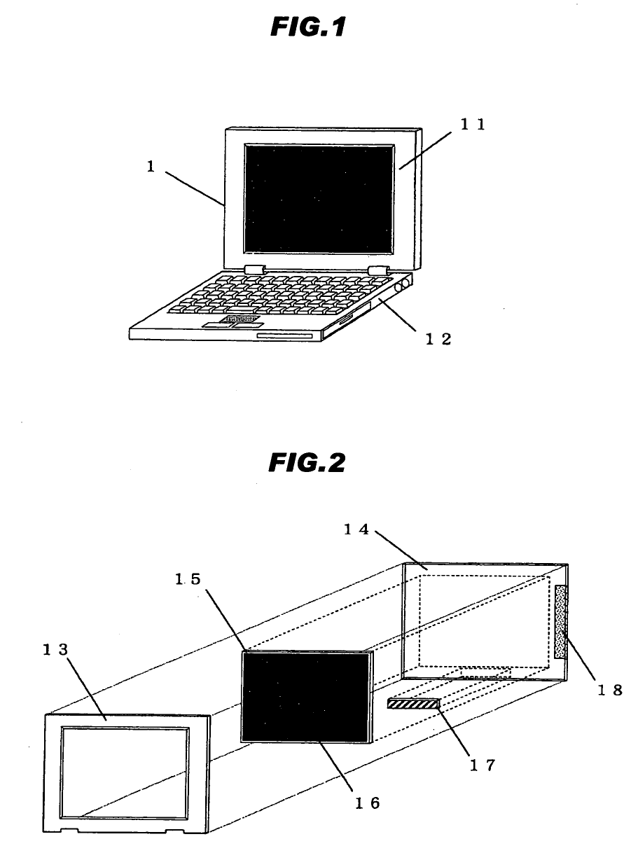

Next, the electrical noises the influence of which is solved by the embodiment of the invention described above will be described below with reference to FIGS. 1 to 10.

FIG. 1 shows an external appearance of a notebook-size PC 1 as an example of a mobile terminal or electrical apparatus having an antenna built therein. The notebook-size PC 1 is composed of an LCD chassis 11 and a keyboard chassis 12, and thus the antenna is generally built either in the LCD chassis 11 or in the keyboard chassis 12.

FIG. 2 is an exploded perspective view of the LCD chassis 11 shown in FIG. 1. An LCD main body 15 having a metallic frame 16, and an inverter circuit 17, composed of a circuit board and the like, for supplying an electric power to the LCD main body 15 are accommodated in the LCD chassis 11. The LCD main body 15 and the inverter circuit 17 are mounted to a front cover 13 or a chassis case 14 of the LCD chassis 11 by using an adhesive tape, a mounting jig, screws made of a metal, and the like. A device circuit for controlling scanning lines of the LCD is provided on a back side of a screening surface of the LCD main body 15 accommodated in the LCD chassis 11. The measures to prevent the electric wave interference with other electrical apparatuses caused by the electrical noises generated from an oscillator on the device circuit, and the electrical noises generated from an oscillator on the inverter circuit 17 are taken in the LCD chassis 11. It is noted that the specification of the LCD main body 15, and the material or the like of which an LCD chassis case 14 is made may differ depending on the differences in methods for the measures thus taken. As an example thereof, when the LCD main body (hereinafter referred to as “the interference measures type LCD” for short) 15 is used in which all portions including the metallic frame 16 except for the screening surface are covered with a metal, and an electrical grounding part dedicated to the LCD main body 15 is provided which is electrically connected to a grounding portion of a power source within the keyboard chassis 12 or an external power source, the LCD chassis case 14 is made of a nonmetal such as plastic in rare cases. On the other hand, the LCD main body (hereinafter referred to as “the interference unmeasures type LCD” for short) 15 is used in which the metallic frame 16 is provided only in the circumference of the screening surface, and the back side of the screening surface (another portion) is covered with no metal, and also the interference measures are taken such that the LCD chassis case 14 is made of a metal or nonmetal, and a conductive coating is applied to the entire inner side (an internal surface having the LCD main body 15 and the like accommodated therein) of the LCD chassis case 14. Also, each of the LCD chassis case 14, the LCD main body 15, and the inverter circuit 17 is electrically connected to a grounding portion of a power source within the keyboard chassis 12 or the external power source. With this structure, for the purpose of further enhancing the effect of the electrical grounding of the LCD main body 15, in general, a part of the metallic frame 16 of the LCD main body 15 is processed, and the resulting metallic frame 16 is electrically connected to the LCD chassis case 14 by using the tape, the screws and the like which are made of the metals, respectively. However, in addition thereto, a dedicated electrical grounding part is specially provided in some cases. It is noted that such a structure may be similarly adopted in the inner circuit 17 as well. An antenna cover 18 mounted to a part of the LCD chassis case 14 for which such electric wave interference measures are taken, and an LCD front surface chassis cover 13 are generally made of plastic materials, respectively. Also, built-in antenna elements are disposed within a range of the antenna cover 18. Note that, the reason that the LCD front surface chassis cover 13 and the antenna cover 18 are made of the plastic materials, respectively, is because the electric wave can be transmitted and received from and at the built-in antenna. It goes without saying that such a structure is adopted in the mobile terminal or electrical apparatus having the antenna built therein. It is noted that the LCD chassis case 14 described above is made of the nonmetal, the antenna cover may be omitted.

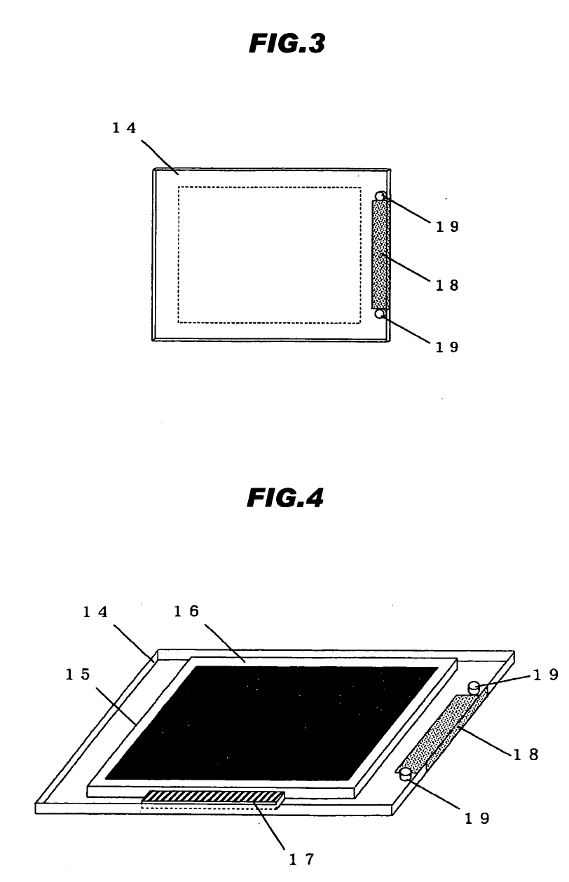

FIG. 3 shows screw receiving holes 19 which are provided in the circumference of the antenna cover 18 of the LCD chassis case 14 shown in FIG. 2, and with which the built-in antenna is fixed to the LCD chassis case 14. The provision of these screw receiving holes 19 has been recently popular. When the LCD chassis case 14 is made of the metal, normally, it is fabricated by performing the casting, and thus each of the screw receiving holes 19 is also made of a metal. On the other hand, when the LCD chassis case 14 is made of the nonmetal and the conductive coating is applied thereto, in general, the conductive coating is similarly applied to each of the screw receiving holes 19.

FIG. 4 shows the LCD chassis 11, shown in FIGS. 1 to 3, from which the front surface chassis cover 13 is detached, and also shows a positional relationship among the LCD main body 15 having the metallic frame 16 installed in the LCD chassis case 14, the inverter circuit 17, the antenna cover 18, and the screw receiving holes 19 in the form of a perspective view.

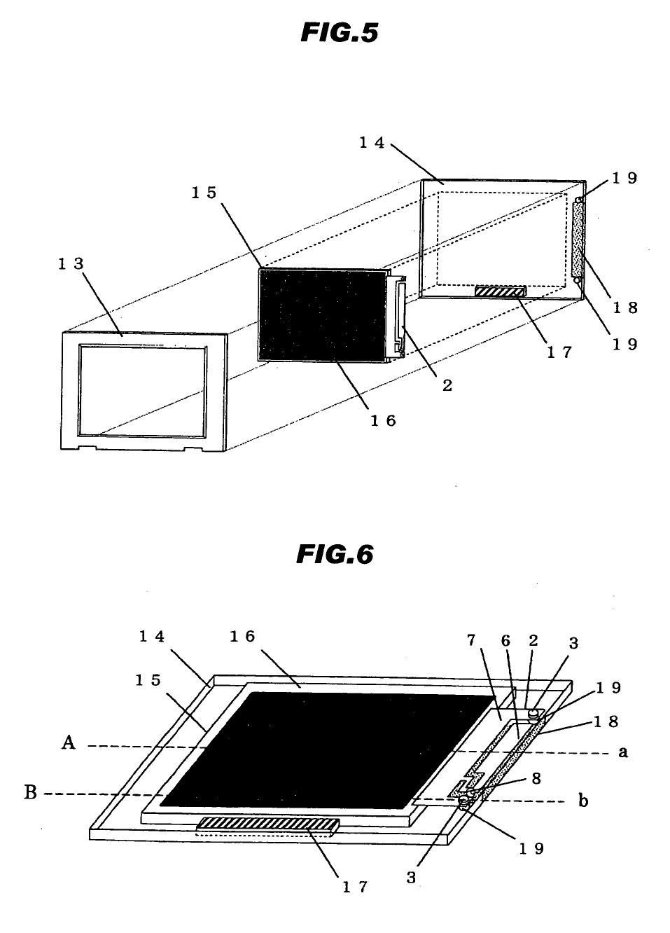

FIG. 5 shows a constriction of the LCD chassis 11, as shown in FIGS. 1 to 4, in which a plate antenna 2 is mounted to the metallic frame 16 of the LCD main body 15 to be built.

FIG. 6 shows the construction of the LCD chassis 11 shown in FIG. 5 in the form of a perspective view similarly to the case of FIG. 4.

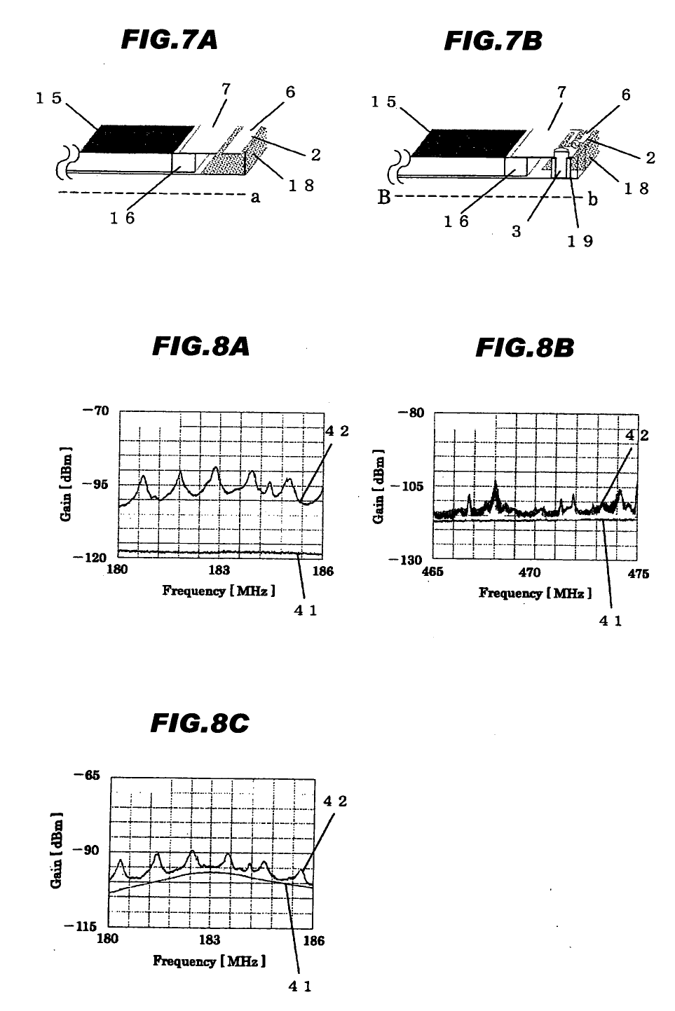

Moreover, FIGS. 7A and 7B are respectively a cross-sectional view taken on line A-a of FIG. 6, and a cross-sectional view taken on line B-b of FIG. 6. A ground 7 of the plate antenna 2 is electrically grounded to the metallic frame 16 of the LCD main body 15, the antenna element 6 is disposed within the range of the antenna cover 18, fixing screws 3 are respectively inserted through screw through holes 10 formed in the plate antenna 2, and the fixing screws are fastened to the screw through holes 10, respectively, thereby fixing the plate antenna 2 to the LCD chassis case 14. It is noted that although a fixing screw made of a metal is generally used as each of the fixing screws 3, a fixing screw made of a nonmetal is used as each of the fixing screws 3 in rare cases. When the plate antenna 2 shown in FIG. 5 to FIGS. 7A and 7B is built in the LCD chassis 11 of the notebook-size PC 1, turn-ON of the power source of the notebook-size PC 1 results in that the oscillator on the inverter circuit 17, and the oscillator on the device circuit accommodated in the LCD main body 15 operate, so that the electrical noises generated from these oscillators as the generation sources of the electrical noises invade the plate antenna 2.

Next, a description will be given with respect to the results pf measurements of the electrical noises invading the plate antenna 2 shown in FIG. 5 to FIGS. 7A and 7B with reference to FIGS. 8A to 8C.

FIGS. 8A to 8C respectively show characteristics of the electrical noises invading the plate antenna 2 in the notebook-size PC 1, shown in FIG. 1, in which the plate antenna 2 is built in the state shown in FIG. 5 to FIGS. 7A and 7B. Also, FIGS. 8A to 8C respectively show the results of the measurements of frequency gain characteristics. In these figures, an axis of abscissa represents a frequency, and an axis of ordinate represents a gain. It is noted that the measurements are carried out in the environment in which the plate antenna 2 does not receive thereat the unrelated extraneous electric wave, the electric power is fed to the plate antenna 2 by using a coaxial cable, and this coaxial cable is used as a feeder cable. Also, the feeder cable is made to extend in a direction opposite to a certain length direction of the antenna element(s) of the plate antenna 2 when viewed from a feeding point, and is prevented from contacting the LCD main body 15.

Firstly, a description will be given with respect to spectral graphs shown in FIGS. 8A and 8B, respectively. Each of FIGS. 8A and 8B shows a comparison in frequency gain characteristics between presence of the turn-ON of the power source of the notebook-size PC 1 and absence of the turn-ON of the power source of the notebook-size PC 1. In this case, the constructions of the LCD chassis used 11 are different from each other. The frequency gain characteristics shown in FIG. 8A are measured under a condition that the LCD chassis case 14 is made of a metal, the interference unmeasures type LCD main body 15 is used, a part of the metallic frame 16 of the LCD main body 15 is processed, the resulting metallic frame 16 and the LCD chassis case 14 are electrically connected to each other, and at the same time, in addition to the metallic frame 16 of the LCD main body 15, the LCD chassis case 14 is electrically grounded. On the other hand, the frequency gain characteristics shown in FIG. 8B is measured under a condition that the LCD chassis case 14 is made of plastic, the interface measures type LCD 15 is used, an electrical grounding part dedicated to the LCD main body 15 is also provided, and the plate antenna 2 is fixed to the LCD chassis case 14 by using the fixing screws 3 made of a nonmetal. In FIGS. 8A and 8B, frequency gain characteristics 41 when the power source of the notebook-size PC 1 is not yet turned ON show a floor noise level, and frequency gain characteristics 42 when the power source of the notebook-size PC 1 is held in the ON state show a strength of the electrical noise invading the plate antenna 2. Thus, the frequency gain characteristics 42 in each of FIGS. 8A and 8B show the result that the electrical noises generated from the oscillator on the inverter circuit 17 activated by turning ON the power source of the notebook-size PC 1, and the electrical noises generated from the oscillator on the device circuit within the LCD main body 15 are transmitted through the metallic portion within the LCD chassis 11 to invade the plate antenna 2 through the metallic portion electrically connected to the plate antenna 2, or are propagated through the space to invade the plate antenna 2. Note that, the reason that the frequency band measured of FIG. 8A is different from that of FIG. 8B is because the plate antennas 2 which have the same structure, and are different in operating frequency band from each other are used in the two cases, respectively.

The electrical noises shown in each of FIGS. 8A and 8B show a tendency to continuously and remarkably appear not only in the operating frequency band (design-based frequency band) of the plate antenna 2, but also in a band ranging from a several hertz band to a several hundreds megahertz band. The feature of the electrical noises differs depending on a size of the LCD main body 15 used, presence or absence of the electric wave interference measures, degree of the electric wave interference measures, and a size, a material, a structure and the like of the LCD chassis 11 accommodating therein the LCD main body 15 in some cases. Therefore, although the difference in feature of the frequency gain characteristics shown in FIGS. 8A and 8B depends on the difference in LCD chassis used, this respect will be described later.

Next, the measurement results shown in FIG. 8C will be described below. FIG. 8C shows a comparison in frequency gain characteristics between presence of the turn-ON of the power source of the notebook-size PC 1 and absence of the turn-ON of the power source of the notebook-size PC 1 in an environment in which the plate antenna 2 receives thereat the incoming electric wave having a weak strength in the operating frequency band of the plate antenna. It is noted that a continuous electric wave having an adjusted strength is used as the incoming electric wave in the phase of the measurements. In FIG. 8C, the frequency gain characteristics 41 when the power source of the notebook-size PC 1 is not yet turned ON represent a strength of a signal received at the plate antenna 2 itself under the measurement environment. On the other hand, the frequency gain characteristics 42 when the power source of the notebook-size PC 1 is held in the ON state represent a strength of a signal, received at the plate antenna 2, containing therein the electrical noises invaded. FIG. 8C suggests that the strength of the electrical noises may be stronger than that of the signal received at the plate antenna 2 itself in the environment in which the strength of the incoming electric wave is weak. That is to say, the strength of the electrical noises may be stronger than that of the pure signal received at the plate antenna 2 in the signal inputted to a reception tuner, which exerts an influence on signal processing executed in the reception tuner. As a result, this induces a state in which received information can not be displayed on an image display apparatus such as the LCD.

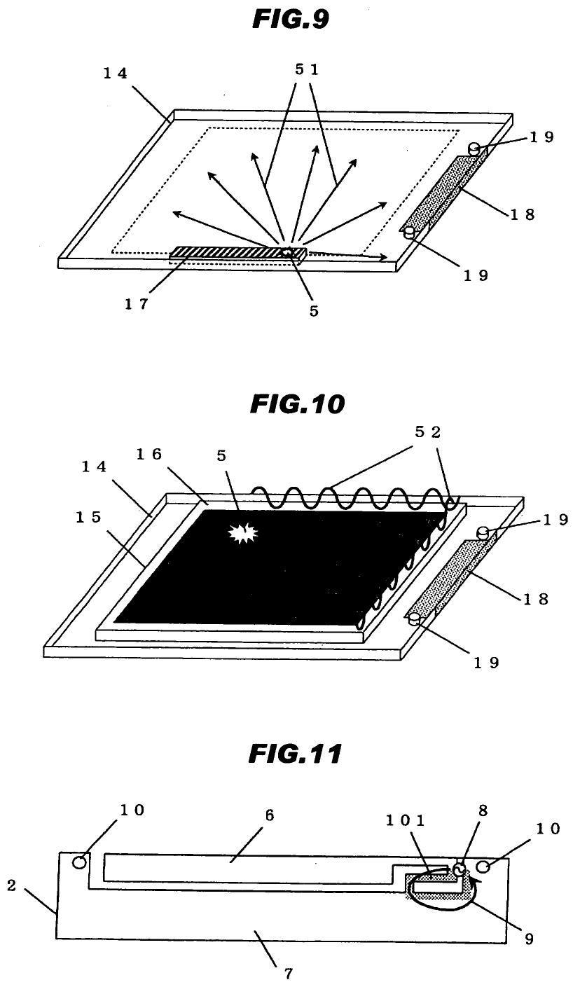

Next, a description will be given with respect to paths of the electrical noises invading the plate antenna 2 shown in FIG. 5 to FIGS. 7A and 7B with reference to FIGS. 9 and 10.

FIG. 9 shows a state in which in the LCD chassis 11 showing the frequency gain characteristics of FIG. 8A, electrical noises 51 generated from an electrical noise generating source (oscillator) 5 on the inverter circuit 17 are transmitted on the LCD chassis case 14. The electrical noises 51 are transmitted on the LCD chassis case 14 with the noise generating source 5 as a center, and a strength of each of them is strongest in the circumference of the noise generating source 5, and becomes weaker with distance from the noise generating source 5. In addition, the electrical noises (not shown) propagated through the space are similarly omnidirectionaly propagated through the space with the noise generating source 5 as a center, and a strength distribution thereof is the same as that of the electrical noises 51 transmitted on the LCD chassis case 14. It is noted that since there are other metallic bodies such as the LCD main body 15 in the actual LCD chassis 11, the transmission directions of the electrical noises may change depending on the circumstances. As a result, the electrical noises 51 transmitted on the LCD chassis case 14 pass through the fixing screws 3 made of the metal via the screw receiving holes 19 on the LCD chassis case 14 to invade the plate antenna 2 through the portion fixing the plate antenna 2. Also, the electrical noises propagated through the space are received at the plate antenna 2 to invade the same. Note that, in the case of the LCD chassis 11 showing the frequency gain characteristics of FIG. 8B, there is no electrical noise 51 transmitted on the LCD chassis case 14 because the LCD chassis case 14 is made of a nonmetal. However, the electrical noises propagated through the space exist, and are also received at the plate antenna 2 to invade the same.

FIG. 10 shows a state in which the electrical noises 52 generated from the noise generating source (oscillator) 5 on the device circuit accommodated in the interference unmeasures type LCD main body 15 in the LCD chassis 11 showing the frequency gain characteristics of FIG. 8A are transmitted on the metallic frame 16 of the LCD main body 15. In the LCD chassis 11, the metallic frame 16 and the LCD chassis case 14 form a resonance structure. Thus, the electrical noises 52 are transmitted on the metallic frame 16 while generating a standing wave due to the resonance structure. Even when the electrical noise generating source 5 is located on the back side of the screening surface of the LCD main body 15, the electrical noises (not shown) propagated through the space omnidirectionaly spread to the space with the electrical noise generating source 5 as a center on the screening surface (upper surface) side of the LCD main body 15, whereas the electrical noises attenuate while being reflected between the LCD chassis case 14 and the LCD main body 15 on the back side of the screening surface. However, this becomes a factor for the electrical noises. As a result, those electrical noises pass through the fixing screws 3 made of the metal via a portion in which the plate antenna 2 is electrically grounded to the metallic frame 16 of the LCD main body 15. Or, the electrical noises propagated through the space pass through the fixing screws 3 made of the metal via the screw receiving holes 19 on the LCD chassis case 14 to be received at the plate antenna 2 via a portion in which the plate antenna 2 is fixed. Thus, such electrical noises invade the plate antenna 2. Note that, in the case of the LCD chassis body 11 showing the frequency gain characteristics of FIG. 8B, the strength of the electrical noises 52 accompanied by the standing wave as shown in FIG. 10 becomes very weak because the LCD main body 15 is of the interference measures type, and the electrical grounding dedicated to the LCD main body 15 is provided. However, the LCD main body 15 has the construction of being covered with the metal. For this reason, the electrical noise generating source 5 on the device circuit is approximately surrounded by the metal. Thus, the resonances having a plurality of frequencies are generated inside the LCD main body 15, and the electrical noises due to these resonances are transmitted on the metal covering the LCD main body 15 and propagated through the space to be received at the plate antenna 2 through the portion in which the plate antenna 2 is electrically grounded, thereby invading the plate antenna 2.

The electrical noises as shown in FIGS. 8A to 8C invade the plate antenna 2 built in the LCD chassis 11 shown in FIG. 5 to FIGS. 7A and 7B owing to the paths of the electrical noises described with reference to FIGS. 9 and 10, and differences in construction of the LCD chassis 11 and the apparatus.

It is difficult to take the electrical noise measures because the electrical noises propagated through the space are almost received at the antenna to invade the antenna. However, it becomes clear from the peculiar measurements that the influence of the electrical noises transmitted through the metallic (conductor) portion existing within the LCD chassis has a tendency to be larger than that of the electrical noises propagated through the spacer. In addition, the strength of the electrical noises generated by each of the oscillators is almost invariable. Thus, in the environment in which the strength of the incoming electric wave in the reception frequency band is strong, the strength of the signal received at the antenna is stronger than that of the electrical noises in most cases. This leads to that it is unnecessary to take the influence of the electrical noises invading the antenna into consideration. However, it is necessary to take the influence of the electrical noises invading the antenna into consideration in the environment in which the strength of the incoming electric wave is weak. It is previously found out from the results of the peculiar investigations using the general reception tuner that when the strength of the signal received at the antenna is stronger than that of the electrical noises, or both the signal received at the antenna and the electrical noises have the equal strength in the environment in which the strength of the incoming electric wave is weak, the reception tuner normally operates without being influenced by the electrical noises.

It is possible to infer from the above that it is necessary for the purpose of solving the problems to realize the antenna structure with which it is possible to effectively reduce the invasion of the electrical noises transmitted through the metallic portion within the LCD chassis 11 into the plate antenna 2, and it is possible to enhance the reception performance.

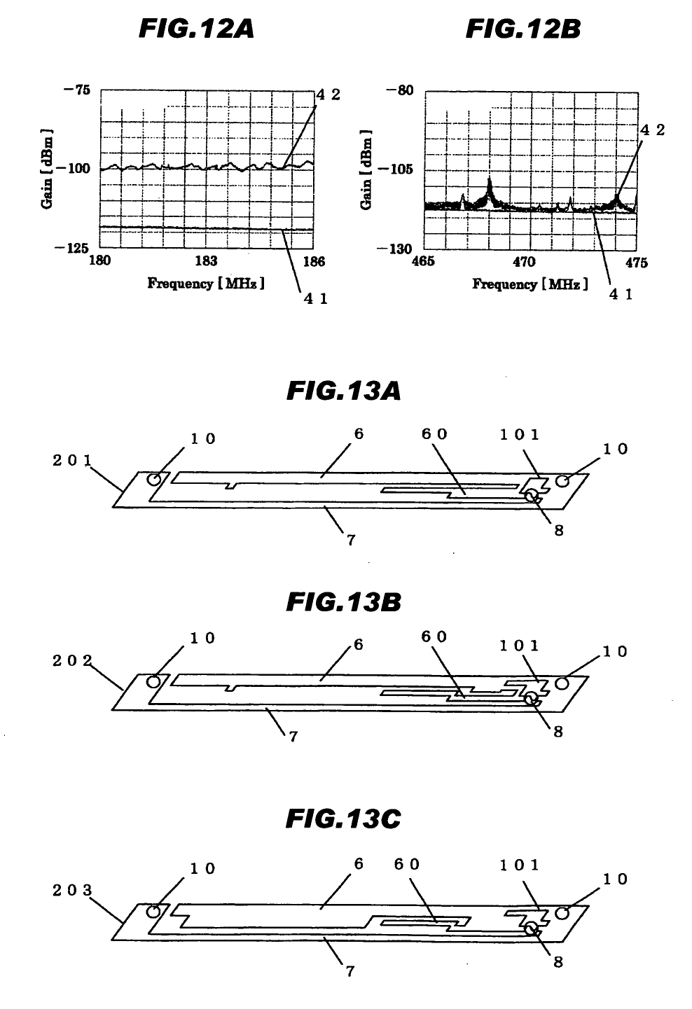

A consideration, about design of an antenna of the present invention, for realizing the solution of the problems described above will now be described with reference to FIG. 11, and FIGS. 12A and 12B.

FIG. 11 shows the plate antenna 2 described with reference to FIG. 5 to FIGS. 7A and 7B (the coaxial cable used for the power feeding is not shown in the figure). The plate antenna 2 has a general plate conductor-like shape in which a short-circuit element 101 for matching is connected from the vicinity of the feeding point 8 of the antenna element 6 to the ground 7. Also, in this structure, the plate antenna 2 includes screw through holes 10 for antenna fixing. By adopting this structure, the plate antenna 2 has an electromagnetic induction loop 9 in the vicinity of the feeding point 8. From the descriptions given with reference to FIGS. 9 and 10, it becomes clear based on the peculiar measurements that the electrical noises invade the plate antenna 2 through the metallic portion of the LCD main body 15 in which the plate antenna 2 is electrically grounded, or through the screw through holes 10 which are connected to the screw reception holes 19 of the LCD chassis case 14 having the electric wave interference measures taken therefor, respectively, and into which the fixing screws 3 made of the metal for fixing the plate antenna 2 are inserted, respectively, so that the electrical noises thus invaded are taken by the electromagnetic induction loop 9.

With regard to the electrical characteristics of the loop structure, there are the electrostatic induction, the electromagnetic induction, and the electric power radiation. Of them, the electrostatic induction is the storage characteristics typically shown by the capacitor, and the electric power radiation is the so-called antenna characteristics. On the other hand, the electromagnetic induction is the characteristics of inducing the electric power of the electric wave or the like. Thus, an amount of generated electric wave thus taken is more in the electromagnetic induction than in the electric power radiation with decreasing a distance to the electric wave generating source. An electromagnetic field probe is known as a typical element using the above characteristics. Also, actually, a distance between the built-in space of the antenna built in the chassis of the mobile terminal or the electrical apparatus, and the part made of the metal, transmitting the electrical noises, disposed close thereto is considerably shorter than the wavelength of the electric waves in the operating frequency of the antenna. This situation also applies to the present invention. For this reason, it may be said that the electromagnetic induction loop 9 caused by the loop structure is one factor for the invasion of the electrical waves into the plate antenna 2.

Next, there are shown the results of measurements of the electrical noises due to the loop structure of the plate antenna 2. FIGS. 12A and 12B show the results of measurements about the influence of the electromagnetic induction loop 9 exerted on the plate antenna 2 shown in FIG. 11. That is, FIG. 12A shows the results of measurements of the frequency gain characteristics before and after turn-ON of the power source of the notebook-size PC 1, using the plate antenna 2, in which the short-circuit element 101 is eliminated from the LCD chassis 11 showing the frequency gain characteristics of FIG. 8A.

FIG. 12B shows the results of measurements of the frequency gain characteristics before and after turn-ON of the power source of the notebook-size PC 1, using the plate antenna 2, in which the short-circuit element 101 is eliminated from the LCD chassis 11 showing the frequency gain characteristics of FIG. 8B.

In each of spectral graphs of FIGS. 12A and 12B, an axis of abscissa represents a frequency, and an axis of ordinate represents a gain.

In each of FIGS. 12A and 12B, the frequency gain characteristics 41 when the power source of the notebook-size PC 1 is not yet turned ON represent the floor noise level, and the frequency gain characteristics 42 when the power source of the notebook-size PC 1 is held in the ON state represent the strength of the electrical noises invading the plate antenna 2. Comparing the results of measurements of the frequency gain characteristics shown in FIGS. 12A and 12B with those shown in FIGS. 8A and 8B when the short-circuit element 101 is used, it is understood that the strength of the electrical noises invading the antenna is reduced. As a result, it is understood that the antenna structure having no electromagnetic induction loop 9 is effective in measures taken to cope with the electrical noises.

However, when the built-in antenna is actually designed, the short-circuit element 101 for matching must be used from the requirements for the miniaturization, the space saving and the like of the antenna itself in many cases. Then, we think that the design, of the antenna, which improves the invasion of the electrical noises is required in consideration of the position and size of the electromagnetic induction loop 9, the transmission paths and their ranges of the electrical noises, the structure with which the antenna element 6 and the ground 7 function independently of each other, and the like. In addition, for the electromagnetic induction loop 9, it is necessary to take a respect as well of the reception of the electrical noises propagated through the space.

Next, a consideration about a concrete structure of the antenna of the present invention for solving the problem about the influence of the electrical noises will be described based on the consideration about the above antenna design.

When the short-circuit element 101 for antenna matching is used, so that the loop structure must be used from the requirement for the miniaturization, the space saving and the like of the antenna as described above, it is necessary to suppress the invasion of the electrical noises into the antenna due to the electromagnetic induction caused by the loop structure. Then, the cause of the invasion of the electrical noises into the antenna will now be discussed from a viewpoint of the antenna.

Firstly, with the structure of the plate antenna 2 shown in FIG. 5 to FIGS. 7A and 7B, and FIG. 11, and the method of building the plate antenna 2 in the LCD chassis 11, the ground 7 of the plate antenna 2 is electrically connected to the metallic frame 16 of the LCD main body 15, and thus it is understood that the invasion (transmission) paths, covering a wide range, of the electrical noises transmitted on the metallic frame 16 exist in the ground portion 7 of the plate antenna 2. In addition, with regard to another invasion path, there are the fixing screws 3, made of the metal, which fix the plate antenna 2 and which are electrically connected to the LCD chassis case 14. The fixing screws 3 also exist in the ground portion of the plate antenna 2. Also, almost the electrical noises transmitted through these invasion paths to travel toward the loop structure are taken due to the electromagnetic induction, and moreover the remaining electrical noises invade the antenna elements through the short-circuit element 101.

Next, with the method of building the plate antenna 2 in the LCD chassis 11, the loop structure of the plate antenna 2 is located in the position closer to the metallic frame 16, of the LCD main body 15, through which the electrical noises are transmitted. For this reason, it is thought that the electrical noises which are transmitted through the metallic frame 16 to be radiated from a discontinuous portion of the metallic frame 16 are taken by the electromagnetic induction through the space.

When in order to suppress the cause of the invasion of the electrical noises into the antenna, the short-circuit element 101 for antenna matching is used, so that the loop structure must be used, it is thought that in the phase of design of the antenna structure, the following measures need to be taken. Firstly, it is given to eliminate the direct invasion path of the electrical noises existing in the ground portion of the plate antenna 2. That is to say, the electrical grounding of the metallic frame 16 of the LCD main body 15 to the ground portion 7 of the plate antenna 2 as the direct invasion path covering the wide range is eliminated, and moreover no fixing screw 3 made of the metal is used. Secondly, it is given that the loop structure is formed in a position located as away from the metallic (conductor) portion transmitting the electrical noises as possible, a structure for impeding the electromagnetic induction is specially provided, and so forth.

With regard to a problem about the first measures described above, although when the fixing screws 3 made of the metal must be used for the fixing of the plate antenna 2 in terms of the strength, the earthquake protection and the like, the metallic frame 16 of the LCD main body 15 is not electrically grounded to the ground 7 of the plate antenna 2 to make it possible to greatly eliminate the invasion paths of the electrical noises, thereby allowing an amount of electrical noises to be largely reduced, it is impossible to perfectly eliminate the invasion paths of the electrical noises existing in the ground portion of the plate antenna 2. However, when the antenna characteristics are taken into consideration, it is the useful means to use the metallic (conductor) portion of the LCD chassis case 14 as the ground of the plate antenna 2. Thus, the structure of the LCD chassis case 14 is considered for the purpose of investigating a method of reducing the influence of the electrical noises invading the plate antenna 2 through the fixing screws 3 made of the metal as much as possible. The metallic frame 16 of the LCD main body 15, and the metallic (conductor) portion of the LCD chassis case 14 are electrically connected to each other within the LCD chassis case 14. That is to say, the electrical noises are transmitted on the metallic (conductor) portion of the LCD chassis case 14 integrated with the metallic frame 16. As a result, when the ground 7 of the plate antenna 2 is fixed to the LCD chassis case 14 by using the fixing screws 3 made of the metal, it is thought that the ground 7 of the plate antenna 2 is also integrated therewith. Since the most part of the loop structure of the plate antenna 2 becoming the problem is composed of the ground portion of the plate antenna 2, and the short-circuit element 101 is used, it is possible to infer that the loop structure of the plate antenna 2 become a structure in which it is easy for the electrical noises to invade the antenna elements as well. Then, it is expected that clarifying the parts of the functions of the antenna element and the ground makes it possible to effectively suppress the invasion of the electrical noises into the antenna.

It is noted that although the plate antenna 2 has the structure which is generally, frequently used, in the phase of the investigation about the reduction in electrical noises of the invention, it was not clear whether or not the antenna elements and the ground function independently of each other.

Next, of the second measures described above, it is considered that in the structure with which it is made clear that the antenna elements and the ground function independently of each other, the ground is used for the structure with which the electromagnetic induction is impeded. When each of the antenna elements is disposed in a position close to the metallic frame 16 at a distance from the metallic frame 16 of the LCD main body 15, there is the possibility that the electrical noises transmitted on the metallic frame 10 to be radiated from a discontinuous portion (a rectangular portion) of the metallic frame 16 are coupled in large amount to the antenna elements, or received in large amount at the antenna elements. For this reason, the ground 7 of the plate antenna 2 is installed as an obstacle between the metallic frame 16 and the antenna elements. As a result, when the electrical noises, transmitted on the metallic frame 16, containing the radiated part are coupled to or received at the ground 7 of the plate antenna 2, it is thought that it becomes possible to suppress the invasion of the electrical noises into each of the antenna elements as long as the ground 7 of the plate antenna 2, and the antenna elements function independently of each other. In addition, the method of disposing the ground 7 of the plate antenna 2 is expected to be the useful means for the case as well where the loop structure is disposed in the position located as away from the metallic (conductor) portion transmitting the electrical noises as possible, this structure being the other of the second measures described above.

Note that, in the case where the characteristics of the antenna is considered for which it is made clear that the antenna elements to realize the measures described above, and the ground function independently of each other, when no metallic portion of the LCD chassis 11 is used as the ground, the sufficient characteristics must be maintained in the antenna itself including both the antenna elements and the ground irrespective of the sizes.

Next, a description will be given with respect to the method of designing the antenna, of the present invention, for solving the problem about the influence of the electrical noises based on the consideration about the concrete structure of the antenna described above.

An antenna structure automatically searching method described in Japanese Patent Laid-Open Nos. 2006-119839 and 2006-345504 filed by the applicant (Hitach Cable, Ltd.) to which the inventors belong is used in the design of the antenna of the present invention.

A method of designing a plate antenna of the present invention utilizing the antenna structure automatically searching method described in Japanese Patent Laid-Open Nos. 2006-119839 and 2006-345504 is described as follows.

Firstly, a calculation region dealt with the antenna structure automatically searching method described above is limited to vertical and horizontal sizes of the plate antenna, all the regions defined by these sizes are discretized into quadrilateral minute segments, and the regions (boundaries) of the antenna elements and the ground are defined along sides of the resulting quadrilateral minute segments. At this time, this definition also applies to the short-circuit element used for the antenna matching. It is noted that the region of the ground is determined in consideration of both that the region of the ground can be disposed close to the metallic frame of the LCD main body, and the position of the screw holes for the antenna fixing. Moreover, the loop structure is formed in the position located as away from the metallic frame of the LCD main body as possible. In addition, the condition that the number of discretized minute segments used in the region of the antenna elements is larger than that used in the region of the ground portion transmitting the electrical noises is added to that condition. Also, the position of the feeding point is defined in consideration of these conditions. In such a manner, the segmentation between the antenna elements and the ground, and the structural conditions therefor are defined as the initial conditions for the antenna structure automatically searching method described above. Next, the region in which the addition and elimination of the discretized minute segments are repeatedly performed is limited to the region, of the antenna elements, thus defined in accordance with the antenna structure automatically searching method described above. The region in which the structural search is performed in the manner described above is limited to the region of the antenna elements, which results in that a plurality of results which are successively calculated by performing the structure researching method described above represent a change in antenna characteristics following a change in only antenna element structure in the given ground state of the antenna, that is, can be regarded as being equal to considering that the antenna elements and the ground function independently of each other. By utilizing the antenna structure automatically researching method described above, it becomes possible to design the antenna structure in which it is considered that the antenna elements and the ground function independently of each other, and thus play the respective parts independently of each other. It is noted that even when the ground itself has a small area (small volume) as in the plate antenna, the structure functioning as the antenna can be designed by utilizing the antenna structure automatically researching method as described above. Details thereof will be described hereinafter based on embodiments of the present invention.

Embodiment 1 of an antenna according to the present invention which solves the problem about the influence of the electrical noises and which is realized in accordance with the consideration and design method described above will be described in detail below with reference to FIGS. 13A to 13C to FIGS. 20A to 20B.

FIGS. 13A to 13C respectively show examples of plate antennas 201, 202 and 203 which are designed and embodied in accordance with the consideration about the antenna design described above. Each of the plate antennas 201, 202 and 203 is composed of antenna elements 6 and 60, and a ground 7 which are formed in conductor plate-like shapes, respectively. Feeding points 8 are set at positions shown in FIGS. 13A to 13C, respectively. Also, the actual feeding is carried out by using a coaxial cable (not shown) or the like. Thus, each of the plate antennas 201, 202 and 203 has fixing screws through holes 10 for antenna fixing. Each of the plate antennas 201, 202 and 203 was fabricated in accordance with the design method described above.

When the plate antenna 201, 202 or 203 is built in the LCD chassis 11, the ground 7 of the plate antenna 201, 202 or 203 is located in a position in a length direction of the plate antennas 201, 202 or 203 so as to be close in parallel to the metallic frame 16 of the LCD main body 15. Also, the ground 7 of the plate antenna 201, 202 or 203 has the fixing screws through holes 10 fir antenna fixing. When the plate antenna 201, 202 or 203 is built in the LCD chassis 11, the loop structure including the short-circuit element 101 is located in a position maintaining a distance from the metallic frame 16 of the LCD main body 15. Also, the feeding point 8 is determined in its position so as to allow this. The greater part of the loop structure is composed of the antenna element 6. In this case, the short-circuit element 101 is contained in a part of the antenna element 6. Of the large and small antenna elements 6 and 60, the small antenna element 60 located in a gap defined between the large antenna element 60 and the ground 7 includes a function as well of maintaining the matching property of the antenna.

Moreover, a slot structure having an open end and having a larger size than that of the loop structure is realized with the feeding point 8 as a boundary by using the antenna elements 6 and 60, and the ground 7, and the feeding point 8. In the case where the antenna element 6 a size of which is larger than that of the small antenna element 60 for maintaining the matching property of the antenna and which constitutes the slot structure is used as the main element for the transmission and reception of the electric wave, it is necessary to maintain a distance to the ground 7 in terms of the characteristics. Also, the small antenna element 60 for maintaining the matching property of the antenna is disposed within the slot due to a restriction following the size of the antenna.

These plate antennas 201, 202 and 203 are designed such that by taking it in the design stage into consideration that the elements, and the ground in the antenna structure function independently of each other, the antenna elements 6 and 60, and the ground 7 play the respective parts independently of each other in each of a boundary between each of the antenna elements 6 and 60, and the feeding point 8, and a boundary between the short-circuit element 101 and the ground 7 having the fixing screw through holes 10, and finally even the single operates as the antenna.

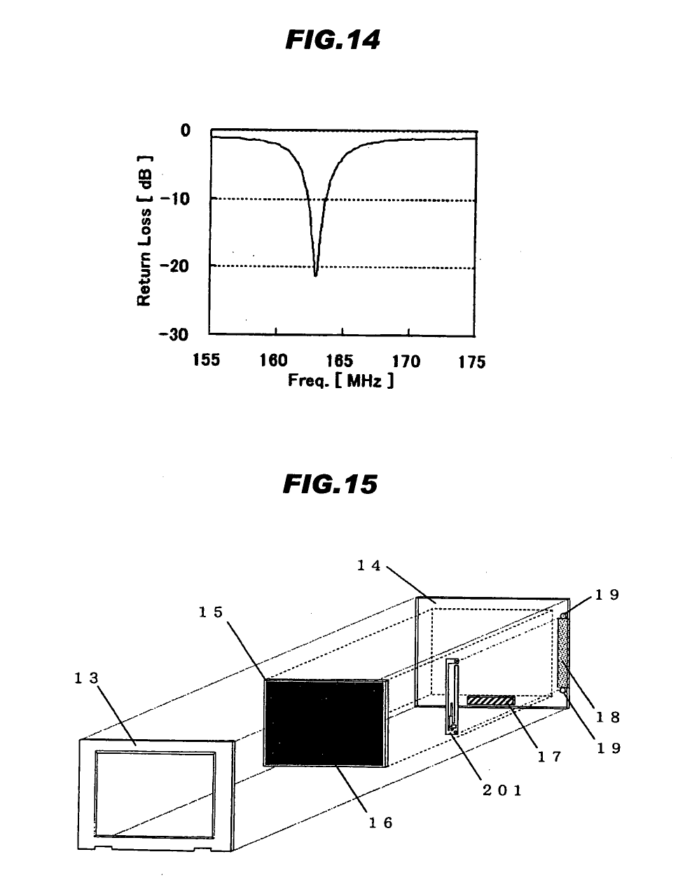

FIG. 14 shows frequency resonance characteristics of the plate antenna 201 itself shown in FIG. 13A. In the figure, an axis of abscissa represents a frequency, and an axis of ordinate represents a return loss.

It is understood from FIG. 44 that the resonance characteristics are held even with the ground 7 itself having the small area (small volume). It is noted that the reason that a frequency range shown in FIG. 14 is different from that shown in FIG. 8A or 8C is that the design is performed in a way such that the plate antenna 201 operates in the same operating frequency band as that shown in FIG. 8A or 8C when the plate antenna 201 is built in the LCD chassis 11.

FIG. 15 shows a construction of the LCD chassis 11 in which the plate antenna 201 shown in FIG. 13A is built. The interference unmeasures type LCD main body 15 is used. In this case, the LCD chassis case 14 is made of the metal, and includes the screw receiving holes 19 and the antenna cover 18 made of plastic. The plate antenna 201 is fixed to the LCD chassis case 14 by screwing metallic fixing screws (not shown) inserted into the respective screw through holes 10 included in the plate antenna 201 into the respective screw receiving holes 19. At the same time, there is provided a state in which the plate antenna 201 is electrically grounded to the LCD chassis case 14. Also, the element portion of the plate antenna 201 is disposed within the range of the antenna cover 18.

In addition, each of the LCD main body 15 and the inverter circuit 18 is fixed so as to be electrically connected to the LCD chassis case 14. This construction is the same as that of each of the LCD chassis 11 showing the frequency gain characteristics of FIG. 8A and the frequency gain characteristics of FIG. 8C except that the built-in plate antenna and the method of building the same in the LCD chassis 11 are different therefrom.

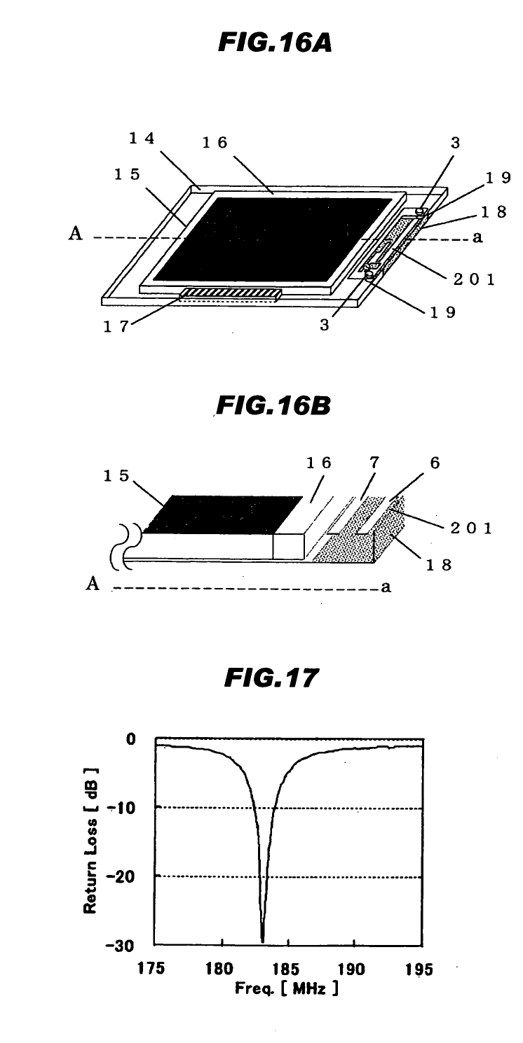

FIGS. 16A and 16B show a state of an inside of the LCD chassis 11 shown in FIG. 15.

FIG. 16A is a perspective view showing a state in which the front cover 13 of the LCD chassis 11 is detached to show a disposition state of the built-in plate antenna 201.

FIG. 16B is a cross-sectional view taken on dotted line A-a of FIG. 16A.

Unlike the case of the plate antenna 2 shown in FIG. 5 to FIGS. 7A and 7B, the plate antenna 201 is not electrically grounded to the metallic frame 16 of the LCD main body 15, but is electrically connected to only the LCD chassis case 14 through the metallic fixing screws 3.

This aims at largely eliminating the paths of invasion of the electrical noises into the antenna. In addition, a coaxial cable (not shown) is connected to the feeding point of the built-in plate antenna 201 and is used as the feeder cable. Also, this coaxial cable is made to extend in a direction opposite to a length direction, along which the antenna elements 6 and 60 of the plate antenna 201 are disposed, when viewed from the feeding point to be disposed within the LCD chassis 11 in consideration of the influence of the electrical noises by, for example, avoiding the contact with the LCD main body 15. It is noted that in the notebook-size PC 1 shown in FIG. 1, a transmission/reception tuner (not shown) is normally installed on a motherboard (not shown) provided within the keyboard chassis 12, and is generally connected to the antenna through the feeder cable.

Actually, the plate antenna 201 is built in the LCD chassis 11, and the feeder cable connected to the feeding point 8 of the plate antenna 201 is passed through a hinge portion through which the LCD chassis 11 and the keyboard chassis 12 are connected to each other to be disposed to a position where the transmission/reception tuner is installed within the keyboard chassis 12.

With this connection method, there is encountered a problem that the transmission loss is large and the strength of each of the transmission signal and the received signal is deteriorated as the feeder cable used is longer. Moreover, there is caused a problem that the degree that the feeder cable itself is influenced in the chassis by the electrical noises becomes large. Thus, in order to connect the antenna and the transmission/reception tuner to each other at a shorter distance, the direction along which the feeder cable is connected to the antenna is preferably selected so as to be made to extend in a longitudinal direction of the keyboard chassis within the LCD chassis. Thus, in FIGS. 16A and 16B as well, the connection direction of the coaxial cable as the feeder cable for the antenna is selected from the above reason.

FIG. 17 shows frequency resonance characteristics of the plate antenna 201 built in the LCD chassis 11 shown in FIGS. 16A and 16B. In the figure, an axis of abscissa represents a frequency, and an axis of ordinate represents a return loss. As described with reference to FIGS. 13A to 13C, and FIG. 14, in the plate antenna 201, it is taken into consideration that the antenna elements 6 and 60, and the ground 7 function independently of each other. Thus, this structure becomes equal to that the ground 7 having the size of the LCD chassis case 14 shown in FIGS. 16A and 16B is simply added to the plate antenna 201.

For this reason, the frequency resonance characteristics shown in FIG. 17 are superior to those shown in FIG. 14. From this fact, it is understood that the enhancement of the characteristics of the antenna itself is realized. Mote that, the reason that the frequency range of the frequency resonance characteristics shown in FIG. 17 is different from that of the frequency resonance characteristics shown in FIG. 14 is because the design is performed by previously taking it into consideration that when the plate antenna 201 is built in the LCD chassis 11, the operating frequency of the plate antenna 201 changes due to the influence of the circumferential environment such as approach of the LCD main body 15 or the like.

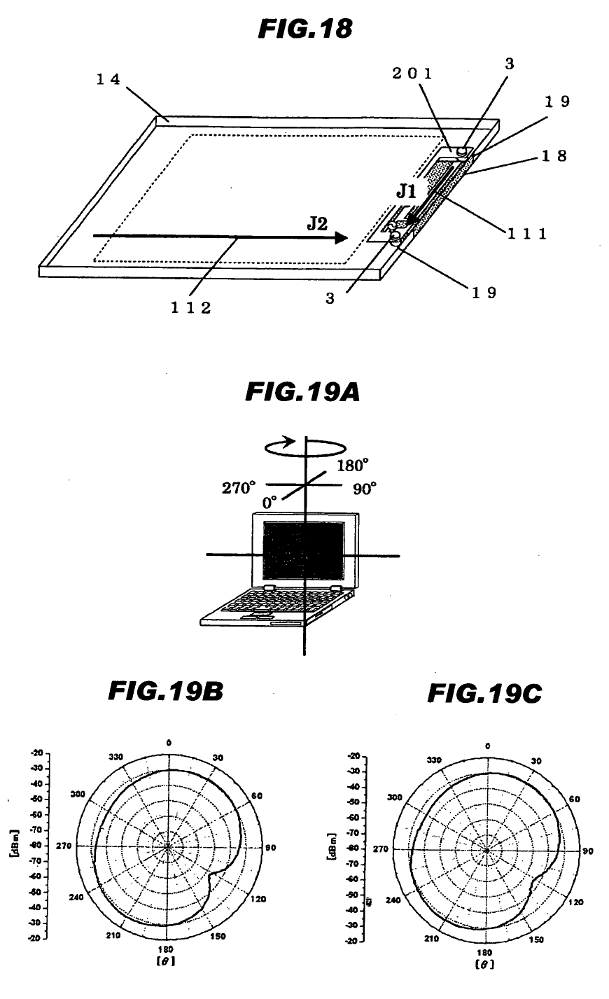

FIG. 18 shows currents contributing to the electric power radiation from the plate antenna 201 in the LCD chassis 11 shown in FIGS. 16A and 16B. A current (J2) 112 peculiar to the limited ground is generated on the LCD chassis case 14 which is electrically connected to the ground 7 of the plate antenna 201 to become a part of the ground 7 of the plate antenna 201. This current (J2) 112 becomes, together with a current (J1) 111 on the antenna element 6 of the plate antenna 201, a current contributing to the electric power radiation from the plate antenna 201.

FIG. 19A is a perspective view explaining a method of measuring a radiation electric field distribution in the notebook-size PC 1 shown in FIG. 1. Also, FIGS. 19B and 19C show results of measurements of the radiation electric field distribution in the notebook-size PC 1, shown in FIG. 1, using the LCD chassis 11 shown in FIGS. 16A and 16B. When only the current (J1) 111 shown in FIG. 18 is the current contributing to the radiation, the current (J1) 111 and a polarized wave component (vertically-polarized wave) in a parallel direction appear more strongly than the current (J1) 111 and a polarized wave component (horizontally-polarized wave) in a vertical direction.

However, the radiation electric field distributions of FIGS. 19B and 19C show that both the polarized wave components appear with equal strength. From this fact, it is obvious that both the current (J1) 111 and the current (J2) 112 shown in FIG. 18 contribute to the radiation from the plate antenna 201. As a result, by utilizing the method of building the plate antenna 201 shown in FIGS. 16A and 16B in the LCD chassis 11, it is possible to radiate both the horizontally-polarized wave and the vertically-polarized wave, and thus it is possible to enhance the radiation gain characteristics.

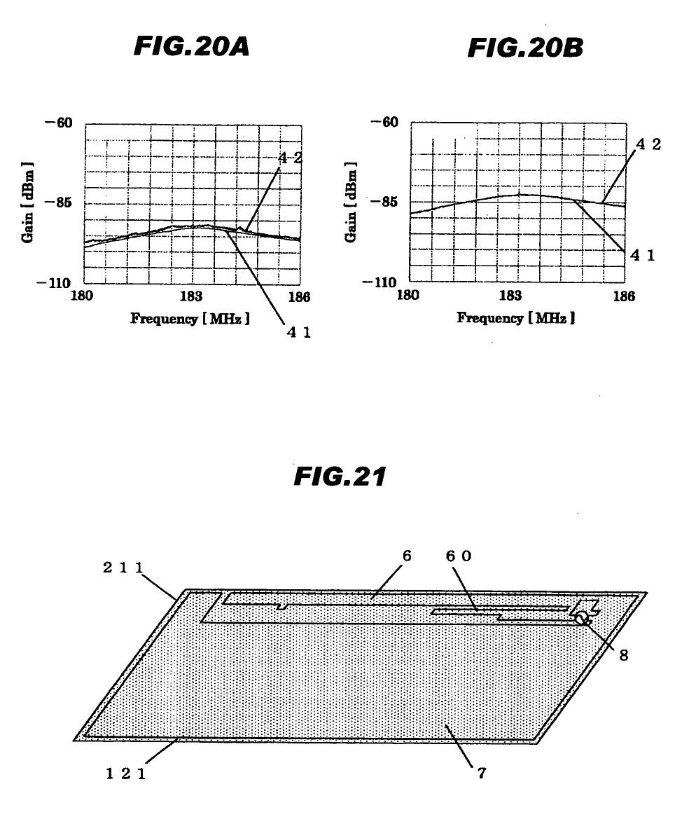

Each of FIGS. 20A and 20B shows a comparison in frequency gain characteristics between presence of the turn-ON of the power source of the notebook-size PC 1 shown in FIG. 1, and absence of the turn-ON of the power source of the notebook-size PC 1 in the environment in which the LCD chassis 11 shown in FIGS. 17A and 16B is used, and the plate antenna 201 receives the incoming electric wave having a weak strength in the operating frequency band of the plate antenna 201. In these figures, an axis of abscissa represents a frequency, and an axis of ordinate represents a gain. It is noted that a continuous electric wave having the adjusted strength is used as the incoming electric wave in the phase of the measurements. In this case, the strength of the incoming electric wave showing the frequency gain characteristics of FIG. 20A is set at the same level as that of the strength of the incoming electric wave showing the frequency gain characteristics of FIG. 8C. Also, in the case of FIG. 20B, the strength of the incoming electric wave is made about 10 Bm stronger that of the incoming electric wave in the case of FIG. 20A in consideration of the variation range of the strength of the electrical noises shown in FIG. 8C. In each of FIGS. 20A and 20B, the frequency gain characteristics 41 when the power source of the notebook-size PC 1 is not yet turned ON represent a strength of a signal received at the plate antenna 2 itself under the measurement environment. Also, the frequency gain characteristics 42 when the power source of the notebook-size PC 1 is held in the ON state represent a strength of a signal, received at the plate antenna 2, containing therein the electrical noises invaded. It is understood from FIG. 20A that there is a small difference between the strength of the signal received at the plate antenna 201 itself and the strength of the electrical noises. That is to say, as compared with the case of FIG. 8A, the invasion of the electrical noises into the plate antenna 201 is greatly reduced. Note that, from the peculiar investigation in which the incoming electric wave is actually received in this state, and the general reception tuner is used, it is previously confirmed that the received information can be displayed on the image displaying apparatus such as the LCD without problems. Moreover, FIG. 20B shows a state in which the influence of the electrical noises can not be perfectly recognized.

As shown in the results of FIG. 17, FIGS. 19A to 19C, and FIGS. 20A and 20B, the antenna of the invention uses the stricture in which the transmission paths of the electrical noises which are transmitted through the metallic (conductor) portion within the chassis in the circumference of the built-in position of the antenna, provided within the chassis of the mobile terminal or the electrical apparatus to invade the antenna are largely cut, and the method of building the antenna in the chassis, and also uses the structure with which the invasion of the electric waves due to the electromagnetic induction is reduced. As a result, the built-in antenna is realized in which the influence of the electrical noises is improved.

Next, Embodiment 2 of the present invention will be described in detail with reference to FIGS. 21 to 24.

FIG. 21 shows a plate antenna 211 which is obtained by lengthening a length of the ground 7 of the plate antenna 201 shown in FIG. 13A and by covering the entire plate antenna 201 with an insulator sheet 121. This structure is an example of a method with which in the case where when the chassis structure of the mobile terminal or the electrical apparatus having the antenna built therein, and the electrical noises invading the antenna are taken intro consideration, and the effect of the electrical grounding of the antenna is investigated, the antenna can not be electrically grounded to the metallic (conductor) portion with the chassis, the size of the ground is increased in consideration of the characteristics of the antenna itself. It is noted that any material may be selected for the insulator sheet 121 covering the plate antenna 211 as long as it has the insulating property as in a paper or polyester.

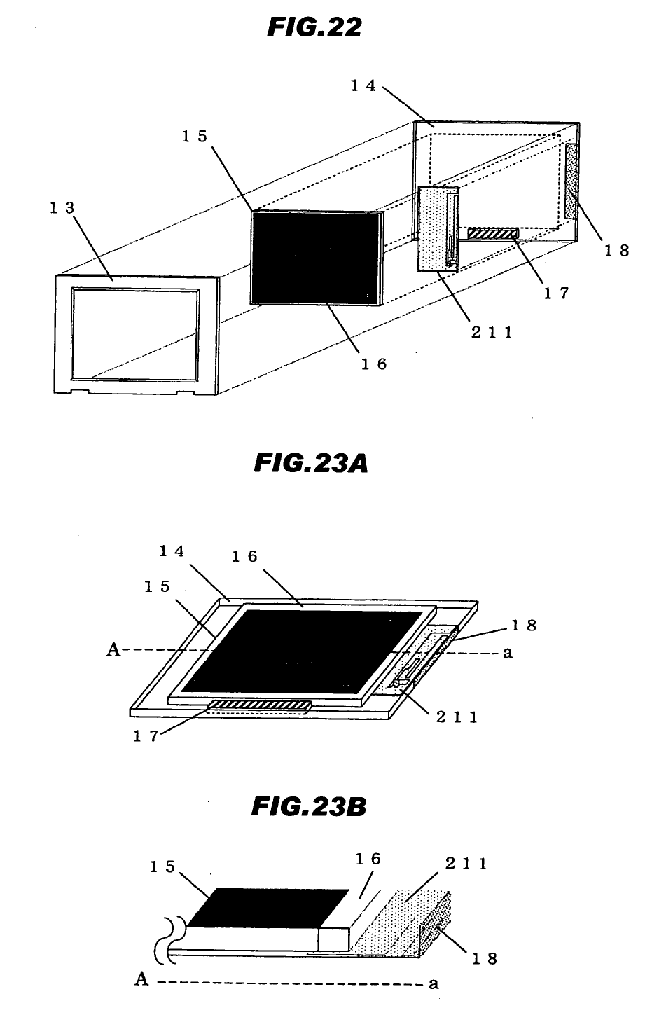

FIG. 22 shows a construction of an LCD chassis in which the plate antenna 211 is built. The interference measures type LCD main body 15 is used. In this case, the LCD chassis case 14 is made of the unmetal, i.e., plastic, and includes the antenna cover 18 made of plastic (When the LCD chassis case 14 and the antenna cover 18 are made of the same material, they may have an integral one-piece). The plate antenna 211 is directly placed on the LCD chassis case 14, and is fixed thereto by using a tape or an adhesive agent (not shown). The antenna elements 6 and 60 of the plate antenna 211 are disposed within a range of the antenna cover 18. Also, the interference measures type LCD main body 15 is connected to a dedicated electrical grounding part (not shown). Moreover, the interference measures type LCD main body 15 is stacked on the ground 7 of the plate antenna 211, and is then fixed, together with the inverter circuit 17, onto the LCD chassis case 14. It is noted that this construction is the same as that of the LCD chassis 11 showing the frequency gain characteristics of FIG. 8B except that the built-in antenna and the method of building the antenna in the LCD chassis 11 are different therefrom. In this installation state, since the entire plate antenna 201 is covered with the insulator (i.e., the insulating sheet 121), it is not electrically connected to the metallic (conductor) part existing within the chassis.

FIGS. 23A and 23B show a state of an inside of the LCD chassis 11 shown in FIG. 22. FIG. 23A is a perspective view showing a state in which the front cover 13 of the LCD chassis 11 is detached to show a disposition state of the built-in plate antenna 211 and the like.

FIG. 23B is a cross-sectional view taken on dotted line A-a of FIG. 23A. The plate antenna 211 is prevented from being directly, electrically connected to the metallic frame 16 of the LCD main body 15 by the insulator sheet 121 covering the entire antenna, which results in that it is possible to suppress the invasion of the electrical noises transmitted through the metallic portion of the LCD main body 15 into the plate antenna 211.

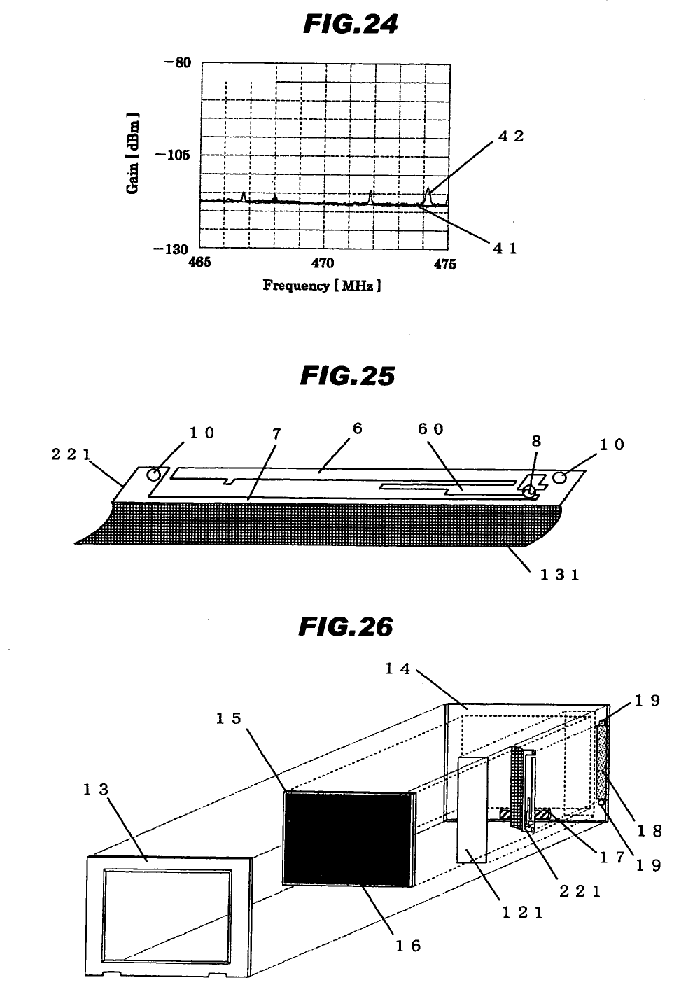

FIG. 24 shows a comparison in frequency gain characteristics between presence of the turn-ON of the power source of the notebook-size PC 1, shown in FIG. 1, using the LCD chassis 11 shown in FIGS. 23A and 23B and absence of the turn-ON of the power source of the notebook-size PC 1. In these figures, an axis of abscissa represents a frequency, and an axis of ordinate represents a gain. In FIG. 24, the frequency gain characteristics 41 when the power source of the notebook-size PC 1 is not yet turned ON represent the floor noise level, and the frequency gain characteristics 42 when the power source of the notebook-size PC 1 is held in the ON state represent the strength of the electrical noises invading the plate antenna 211. Comparing the results of measurements of the frequency gain shown in FIG. 24 with those shown in FIG. 8B, it is understood that the strength of the electrical noises invading the plate antenna is largely reduced. As a result, the built-in plate antenna is realized in which the influence of the electrical noises is improved.

It is noted that Embodiment 2 of the present invention offers the same effects as those in Embodiment 1 even when the range over which the plate antenna 201 is covered with the insulator sheet 121 is limited to only the ground portion of the plate antenna 201.

Next, Embodiment 3 of the present invention will be described in detail with reference to FIG. 25 to FIGS. 27A and 27B.

FIG. 25 shows a plate antenna 221 which is obtained by connecting a flexible conductor sheet 131 to the ground portion of the plate antenna 221 shown in FIG. 13A. In the plate antenna 221, the flexible conductor sheet 131 is electrically connected to the ground 7, and is used as a part of the ground 7. This construction is also an example of the method of increasing the size of the ground 7 in consideration of the characteristics of the plate antenna 221 itself similarly to the case of the plate antenna 211 shown in FIG. 21. Note that, the flexible conductor sheet 131 is electrically connected to the ground 7 by using a solder (not shown), a conductive tape (not shown), or an electrical connection structure (not shown). In this case, the same effects can be obtained even when any of these electrical connection methods is adopted.

FIG. 26 shows a construction of an LCD chassis 11 in which the plate antenna 211 shown in FIG. 25 is built in the LCD chassis 11 shown in FIG. 15. The flexible conductor sheet 131 electrically connected to the ground 7 of the plate antenna 221 is placed on the LCD chassis case 14, and the insulator sheet 121 is sandwiched between the metallic frame 16 of the LCD main body 15, and the plate antenna 221 so as to avoid portions of the antenna elements 6 and 60 of the plate antenna 221. It is noted that any material may be selected for the insulating sheet 121 covering the plate antenna 221 as long as it has the insulating property as in a paper or polyester. In addition, in order to enhance the effect of the electrical grounding of the plate antenna 211, and to improve the stability thereof, the flexible conductor sheet 131 may be fixed to the LCD chassis case 14 by using a conductive adhesive tape or a conductive adhesive agent.

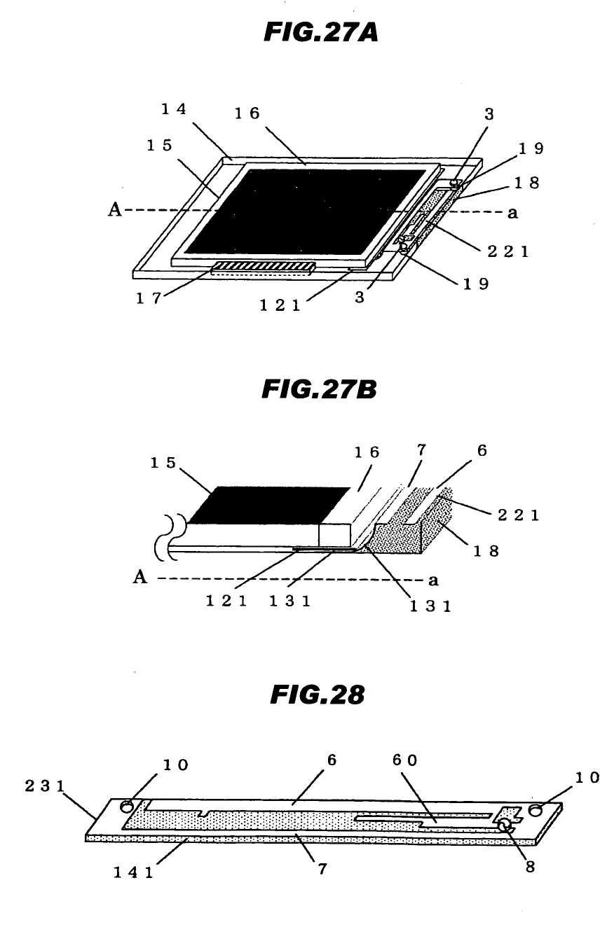

FIGS. 27A and 27B show a state of an inside of the LCD chassis 11 shown in FIG. 26. FIG. 27A is a perspective view showing a state in which the front cover 13 of the LCD chassis 11 is detached to show a disposition state of the built-in plate antenna 201. Also, FIG. 27B is a cross-sectional view taken on dotted line A-a of FIG. 27A. As shown in FIG. 27B, the insulator sheet 121 is sandwiched between the flexible conductor sheet 131 mounted to the plate antenna 221, and the metallic frame 16 of the LCD main body 15. It is noted that a coaxial cable (not shown) is connected to the feeding point of the plate antenna 221, and is disposed within the LCD chassis 11 in consideration of the influence of the electrical noises exerted on the plate antenna 221.

In Embodiment 3 as well, the insulator sheet 121 is sandwiched between the metallic frame 16 of the LCD main body 15, and the plate antenna 221, which results in that they are prevented from being directly, electrically connected to each other to suppress the invasion of the electrical noises transmitted through the metallic portion of the LCD main body 15. As a result, the frequency gain characteristics for which the influence of the electrical noises is improved are obtained similarly to the case of FIGS. 20A and 20B, and thus it is possible to realize the built-in antenna in which the influence of the electrical noises is improved.

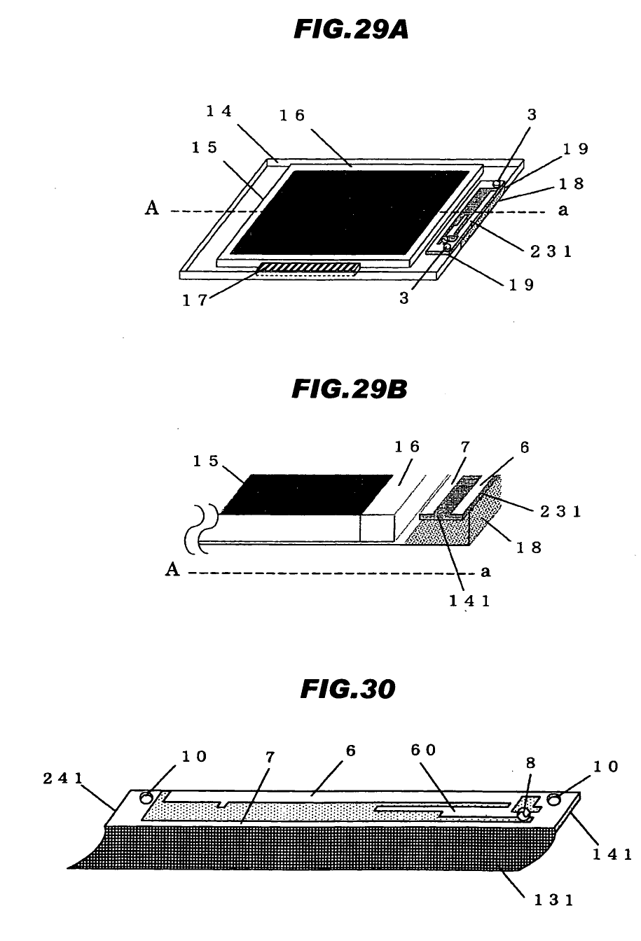

Next, Embodiment 4 of the present invention will be described in detail with reference to FIG. 28 to FIGS. 29A and 29B.

FIG. 28 shows a plate antenna 231 in which the same antenna pattern as that of the plate antenna 201 shown in FIG. 13A is formed on a dielectric substrate 141. The pattern of the antenna is formed from a conductor. The plate antenna 231 includes screw through holes 10 for screw fixing.

FIGS. 29A and 29B show a state of an inside of the LCD chassis 11 shown in FIG. 15 when the plate antenna 231 is built in the LCD chassis 11 shown in FIG. 15A. FIG. 29A is a perspective view showing a state in which the front cover 13 of the LCD chassis 11 is detached to show a disposition state of the built-in plate antenna 222 and the like. FIG. 29B is a cross-sectional view taken on dotted line A-a of FIG. 29A. It is noted that a coaxial cable (not shown) is connected to the feeding point of the plate antenna 231, and is disposed within the LCD chassis 11 in consideration of the influence of the electrical noises exerted on the plate antenna 231.

In Embodiment 4 as well, it is possible to suppress the invasion of the electrical noises into the plate antenna 231. As a result, the frequency gain characteristics for which the influence of the electrical noises is improved are obtained similarly to the case of FIGS. 20A and 20B, and thus it is possible to realize the built-in antenna in which the influence of the electrical noises is improved.

Next, Embodiment 5 of the present invention will be described in detail with reference to FIG. 30.

FIG. 30 shows a plate antenna 241 which is obtained by connecting the flexible conductor sheet 131 used in Embodiment 3 shown in FIG. 25 to the ground 7 of the plate antenna 231 shown in FIG. 28. The electrical connection between the flexible conductor sheet 131 and the ground 7 of the plate antenna 241 is carried out in the same manner as that in the case of Embodiment 3 shown in FIG. 25. Thus, the flexible conductor sheet 131 is electrically connected to the ground 7 of the plate antenna 241 by using a solder (not shown), a conductive tape (not shown), or an electrical connection structure (not shown). In this case, the same effects can be obtained even when any of these electrical connection methods is adopted.

A method of building the plate antenna 241 in the LCD chassis 11 shown in FIG. 15 is the same as that described with reference to FIG. 26 and FIGS. 27A and 27B. Thus, even when the plate antenna 241 is built in the LCD chassis 11 shown in FIG. 15, it is possible to suppress the invasion of the electrical noises into the plate antenna 241. As a result, the frequency gain characteristics for which the influence of the electrical noises is improved are obtained similarly to the case of FIGS. 20A and 20B, and thus it is possible to realize the built-in antenna in which the influence of the electrical noises is improved.

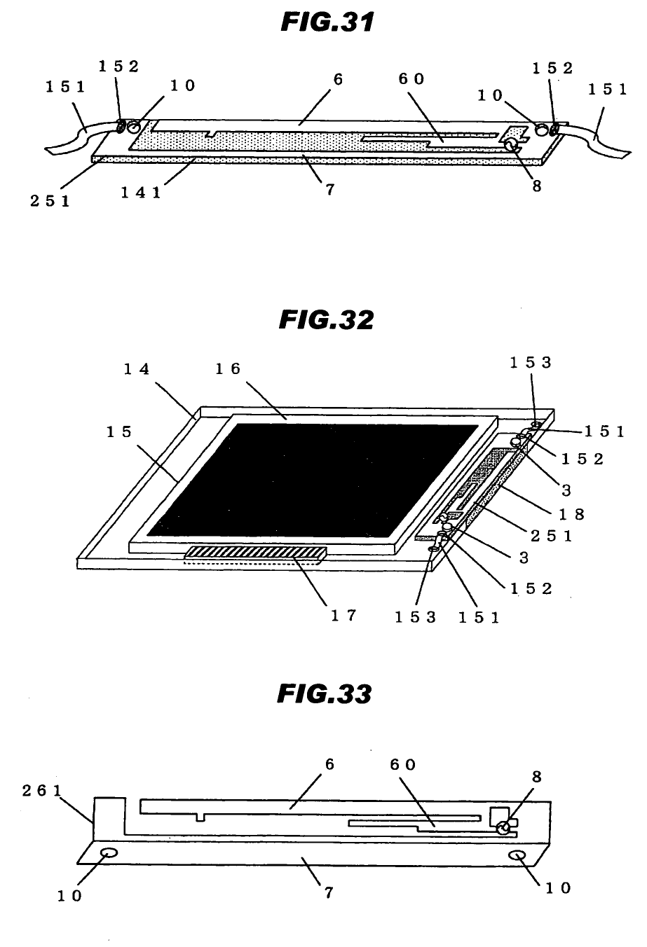

Next, Embodiment 6 of the present invention will be described in detail with reference to FIGS. 31 and 32.

FIG. 31 shows a plate antenna 251 which is obtained by mounting an antenna fixing tape 151 to the ground portion of the plate antenna 231 shown in FIG. 28. A flexible material or a conductive material is selected as a material for the antenna fixing tape 151 depending on use applications and purposes. For the mounting of the antenna fixing tape 151, suitable processing is performed for a mounting portion 152 of the antenna fixing tape 151, or a suitable connection method is used depending on the material selected for the antenna fixing tape 151.

FIG. 32 shows a state of an inside of the LCD chassis 11 shown in FIG. 15 when the plate antenna 251 is built in the LCD chassis 11. When the effect of the electrical grounding of the plate antenna 251 is enhanced by using the fixing tape 151, the fixing tape 151 is made of a conductive material, and a place of the fixing tape portion 152 to which one end of the fixing tape 151 is mounted is adjusted in consideration of the characteristics of the plate antenna 251. Also, one end of the fixing tape 151 is electrically connected to the ground 7 of the plate antenna 251 by performing the soldering, the welding or the like, and the other end of the fixing tape 151 is electrically connected to the LCD chassis case 14 through a portion 153, to which the other end of the fixing tape 151 is mounted, which is determined depending on the situation of the circumference of the antenna fixing position by using a conductive adhesive tape, a solder or a dedicated connector. It is noted that a coaxial cable (not shown) is connected to the feeding point of the plate antenna 251, and is disposed within the LCD chassis 11 in consideration of the influence of the electrical noises exerted on the plate antenna 251.

In Embodiment 6, it is possible to suppress the invasion of the electrical noises into the plate antenna 251 even when one end of the fixing tape 151 is electrically connected to the plate antenna 251 by using a solder, and the other end of the fixing tape 151 is electrically connected to the LCD chassis case 14 by using the conductive adhesive tape. As a result, the frequency gain characteristics for which the influence of the electrical noises is improved are obtained similarly to the case of FIGS. 20A and 20B, and thus it is possible to realize the built-in antenna in which the influence of the electrical noises is improved.

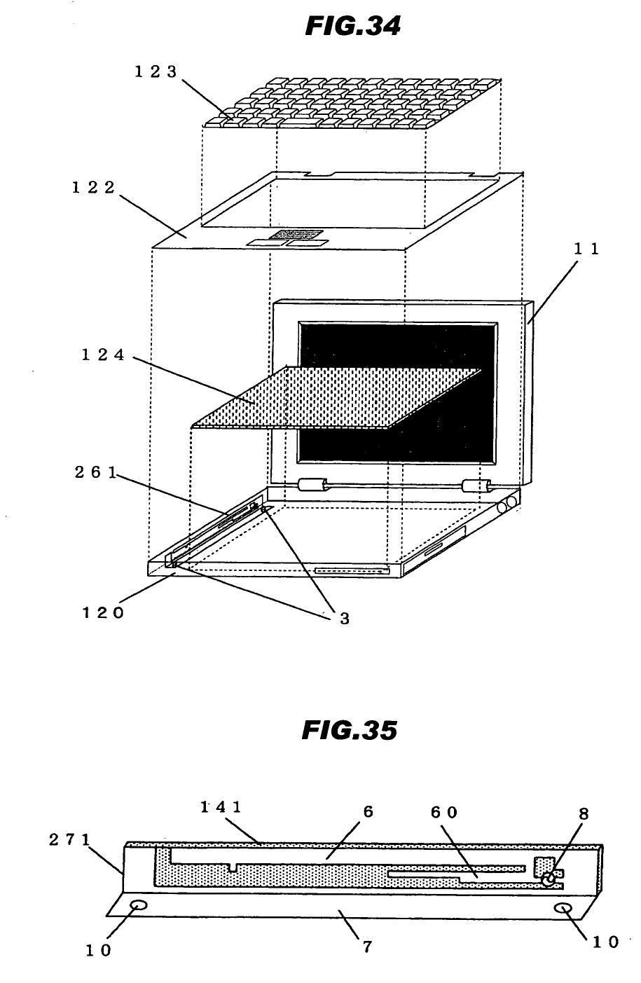

Next, Embodiment 7 of the present invention will be described in detail with reference to FIGS. 33 and 34.

FIG. 23 shows a plate antenna 261 which is obtained by changing the structure of the plate antenna 201 shown in FIG. 13A. The plate antenna 261 is folded at a middle of the ground 7 so that the ground 7 makes a suitable angle with the antenna element 6. This folding angle can be suitably selected depending on the space within the chassis 11 in which the plate antenna 261 is built, or the circumferential situation. For the antenna structure shown in FIG. 33, it is taken in the design stage into consideration that the antenna elements 6 and 60, and the ground 7 of the antenna structure function independently of each other similarly to the case of the plate antenna 201 shown in FIG. 13A. Therefore, the single sufficiently operates as the antenna. It is noted that the frequency resonance characteristics of the plate antenna 261 are the same as those shown in FIG. 14.

FIG. 34 shows a construction of the keyboard chassis 12, shown in FIG. 1, in which the plate antenna 261 of FIG. 33 is built. The plate antenna 261 is folded at the middle of the ground 7, an angle which the antenna element 6 and the ground 7 make with each other is set at a right angle, and the antenna element 6 is disposed in a gap defined by the keyboard chassis 120 and the motherboard 124. When the plate antenna 261 is built in the LCD chassis 11, for the purpose of enhancing the electrical grounding of the plate antenna 261, the plate antenna 261 is electrically connected to a metallic portion (not shown) provided within the keyboard chassis 12. It is noted that a coaxial cable (not shown) is connected to the feeding point of the plate antenna 261, and is disposed within the keyboard chassis 12 in consideration of the influence of the electrical noises exerted on the plate antenna 261.

In Embodiment 7 as well, it is possible to make full use of the feature of the plate antenna 201 shown in FIG. 13A and thus it is possible to suppress the invasion of the electrical noises into the plate antenna 261. As a result, the frequency gain characteristics for which the influence of the electrical noises is improved are obtained similarly to the case of FIGS. 20A and 20B, and thus it is possible to realize the built-in antenna in which the influence of the electrical noises is improved.

Next, Embodiment 8 of the present invention will be described in detail with reference to FIG. 35.

FIG. 35 shows a plate antenna 271 which is obtained by forming the same antenna pattern as that of the plate antenna 261 shown in FIG. 33 on a dielectric substrate 141 and by changing a part of the plate antenna 261. The antenna elements 6 and 60, and a part of the ground 7 are formed from a conductor on the dielectric substrate 141, and the part of the ground 7 formed on the dielectric substrate 141, and a conductor plate or a flexible conductor tape are electrically connected to each other, thereby structuring the ground 7. Note that, this electrical connection is carried out similarly to the case of the plate antenna 241 shown in FIG. 30, that is, the part of the ground 7 is electrically connected to the conductor plate or the flexible conductor tape by using a solder (not shown), a conductive tape (not shown), or an electrical connection structure (not shown). In this case, the same effects can be obtained even when any of these electrical connection methods is adopted.

It is possible to suppress the invasion of the electrical noises into the plate antenna 271 even when the plate antenna 271 is built in the keyboard chassis 12 similarly to the case of the plate antenna 241 shown in FIG. 33. As a result, the frequency gain characteristics for which the influence of the electrical noises is improved are obtained similarly to the case of FIGS. 20A and 20B, and thus it is possible to realize the built-in antenna in which the influence of the electrical noises is improved.

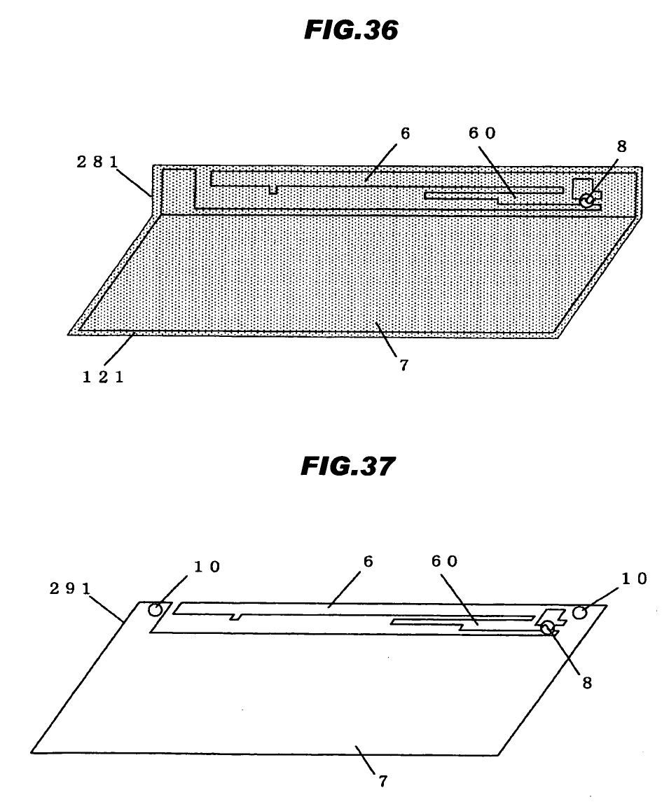

Next, Embodiment 9 of the present invention will be described in detail with reference to FIG. 36.

FIG. 36 shows a plate antenna 281 which is obtained by lengthening a length of the ground 7 of the plate antenna 261 shown in FIG. 33, and by covering the entire plate antenna 261 with the insulator sheet 121. This structure is an example of a method with which in the case where when the chassis structure of the mobile terminal or the electrical apparatus having the antenna built therein, and the electrical noises invading the antenna are taken into consideration, and the effect of the electrical grounding of the antenna is investigated, the antenna can not be electrically grounded to the metallic (conductor) portion provided within the chassis, the size of the ground is increased in consideration of the characteristics of the antenna itself. It is noted that any material may be selected for the insulator sheet 121 covering the plate antenna 281 as long as it has the insulating property as in a paper or polyester.

When the plate antenna 281 is built in the keyboard chassis 12 shown in FIG. 34 similarly to the case of the plate antenna 241 shown in FIG. 33, and is fixed thereto by using a tape or an adhesive agent (not shown), the plate antenna 281 is not electrically connected to the metallic (conductor) part existing within the keyboard chassis 12 because the entire plate antenna 281 is covered with the insulator (i.e., the insulator sheet 121). In this case as well, it is possible to suppress the invasion of the electrical noises into the plate antenna 281. As a result, the frequency gain characteristics for which the influence of the electrical noises is improved are obtained similarly to the case of FIGS. 20A and 20B, and thus it is possible to realize the built-in antenna in which the influence of the electrical noises is improved.

Next, Embodiment 10 of the present invention will be described in detail with reference to FIG. 37.

FIG. 37 shows a plate antenna 291 which is obtained by extending the ground portion of the plate antenna 201 shown in FIG. 13. The plate antenna 291 has a structure in the case where distances to apparatuses (devices) and other metallic (conductor) parts urging the electrical noises to invade the antenna are ensured in a space in which the antenna is built in the chassis of the electrical apparatus, the electrical noises invading the antenna can be reduced based on only the effects of the method of designing the antenna of the invention without using the various methods of reducing the electrical noises described above, the plate antenna 291 can be fixed to the LCD chassis 11 by using only the fixing screws inserted into the respective fixing screw through holes 10 of the plate antenna 291, and the fixing screws are each made of the metal, the sufficient electrical grounding effects can not be obtained even when the fixing screws are electrically connected to the respective screw receiving holes (not shown) formed in the metallic (conductor) part provided within the LCD chassis 11, or in the case where it is necessary for the plate antenna 291 itself to enhance the effects of the electrical grounding. In this case, a length and a width of the ground portion can be freely selected when the effects of the electrical grounding is enhanced.

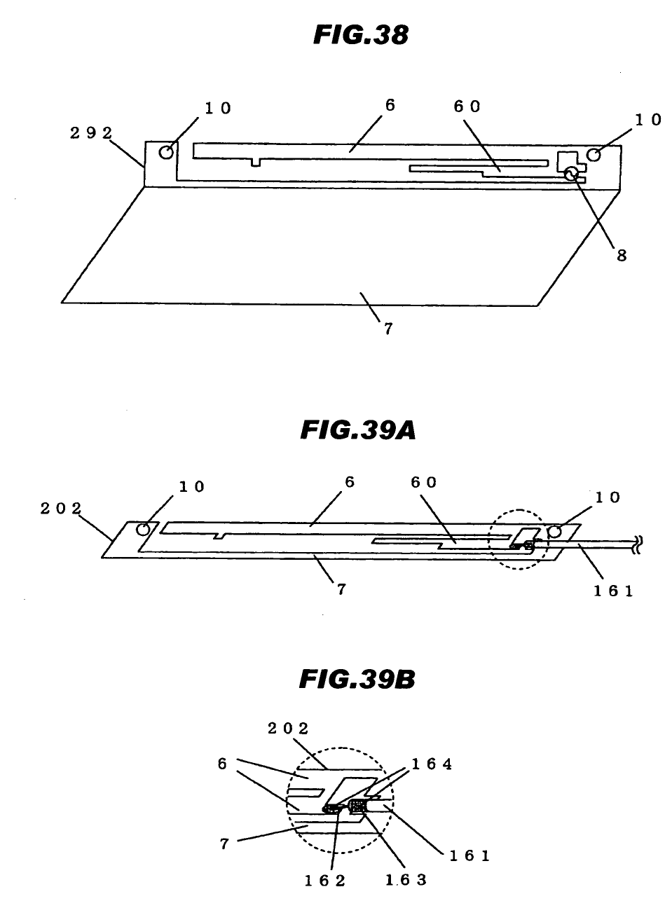

Next, Embodiment 11 of the present invention will be described in detail with reference to FIG. 38.

FIG. 38 shows a plate antenna 292 which is obtained by changing the structure of the plate antenna 291 shown in FIG. 37. The plate antenna 261 is folded at a middle of the ground 7 so that the ground 7 makes a suitable angle with each of the antenna elements 6 and 60. This folding angle can be suitably selected depending on the space within the chassis 11 in which the plate antenna 292 is built, or the circumferential situation. The plate antenna 292 is an example of the structure based on the contents of the description given with reference to FIG. 37.

Next, Embodiments 12 to 22 of the present invention will be described in detail with reference to FIGS. 39A and 39B to FIG. 49, respectively.

FIG. 39 shows an external appearance of the plate antenna 202, according to Embodiment 12 of the present invention, in which a coaxial cable 161 is used as the feeder cable of the plate antenna 201 shown in FIG. 13A. Also, FIG. 39B is a partially enlarged view of a connection state of the coaxial cable 161 indicated by a dotted-line circle. A solder 164 is used for connection of the coaxial cable 161, and each of an inner conductor 162 and an outer conductor 163 of the coaxial cable 161 is electrically connected to the antenna feeding portion. It is noted that any other suitable method such as use of a dedicated connector may be used as this connection method, and thus this connection method can be suitably selected depending on easiness of a connection process or the purposes such as holding of a strength of a connection portion. In addition, a length direction of the coaxial cable 161 can be freely selected depending on a method of building the antenna in the chassis or a method of accommodating the cable.

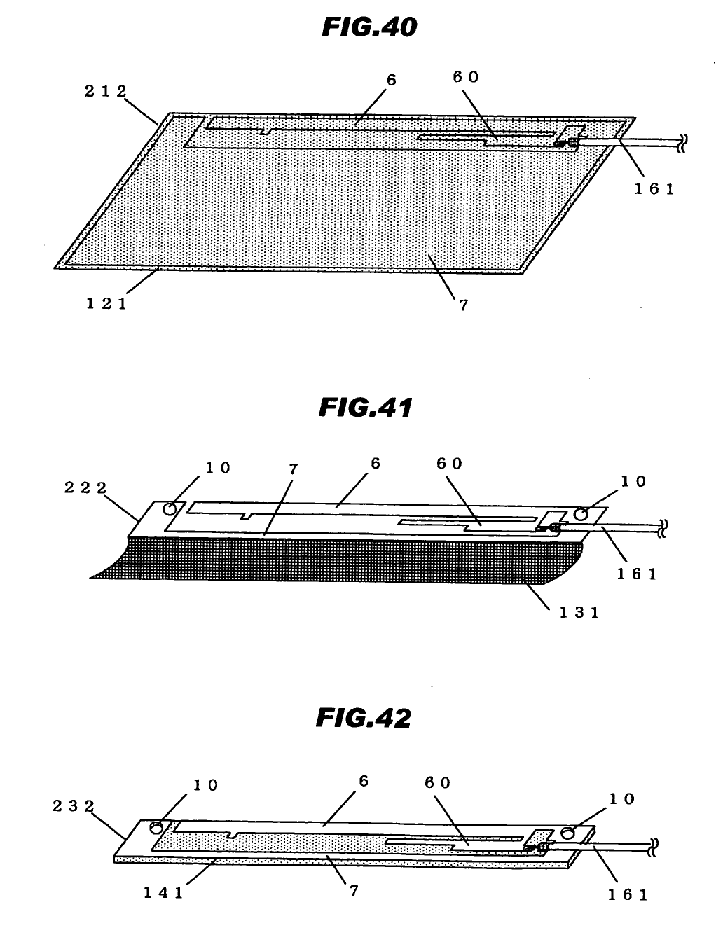

It is noted that in Embodiments 13 to 22 as well shown in FIGS. 40 to 49, respectively, the electrical connection of the coaxial cable is carried out by using the soldering similarly to the case of Embodiment 9 shown in FIG. 36. Also, any other suitable method such as use of a dedicated connector can be applied to the connection of plate antennas shown in FIGS. 40 to 49, respectively, and thus this connection method can be suitably selected depending on easiness of a connection process or the purposes such as holding of a strength of a connection portion.

FIG. 40 shows an external appearance of a plate antenna 212, according to Embodiment 13 of the present invention, using a coaxial cable 161 as the feeder cable of the plate antenna 211 shown in FIG. 21.

FIG. 41 shows an external appearance of a plate antenna 222, according to Embodiment 14 of the present invention, using the coaxial cable 161 as the feeder cable of the plate antenna 221 shown in FIG. 25.

FIG. 42 shows an external appearance of a plate antenna 232, according to Embodiment 15 of the present invention, using the coaxial cable 161 as the feeder cable of the plate antenna 231 shown in FIG. 28.

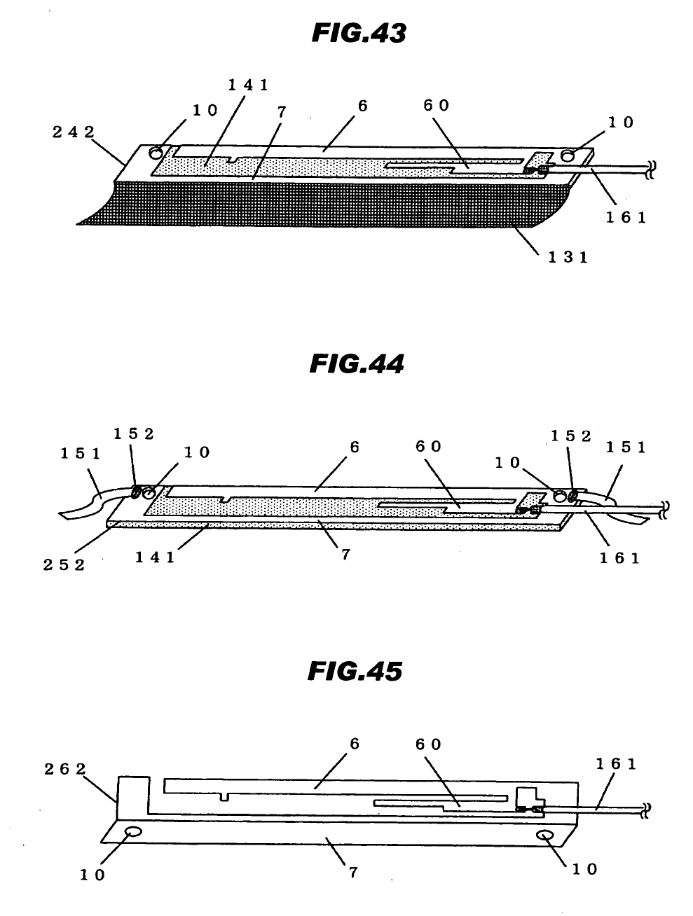

FIG. 43 shows an external appearance of a plate antenna 242, according to Embodiment 16 of the present invention, using the coaxial cable 161 as the feeder cable of the plate antenna 241 shown in FIG. 30.

FIG. 44 shows an external appearance of a plate antenna 252, according to Embodiment 17 of the present invention, using the coaxial cable 161 as the feeder cable of the plate antenna 251 shown in FIG. 31.

FIG. 45 shows an external appearance of a plate antenna 262, according to Embodiment 18 of the present invention, using the coaxial cable 161 as the feeder cable of the plate antenna 261 shown in FIG. 33.

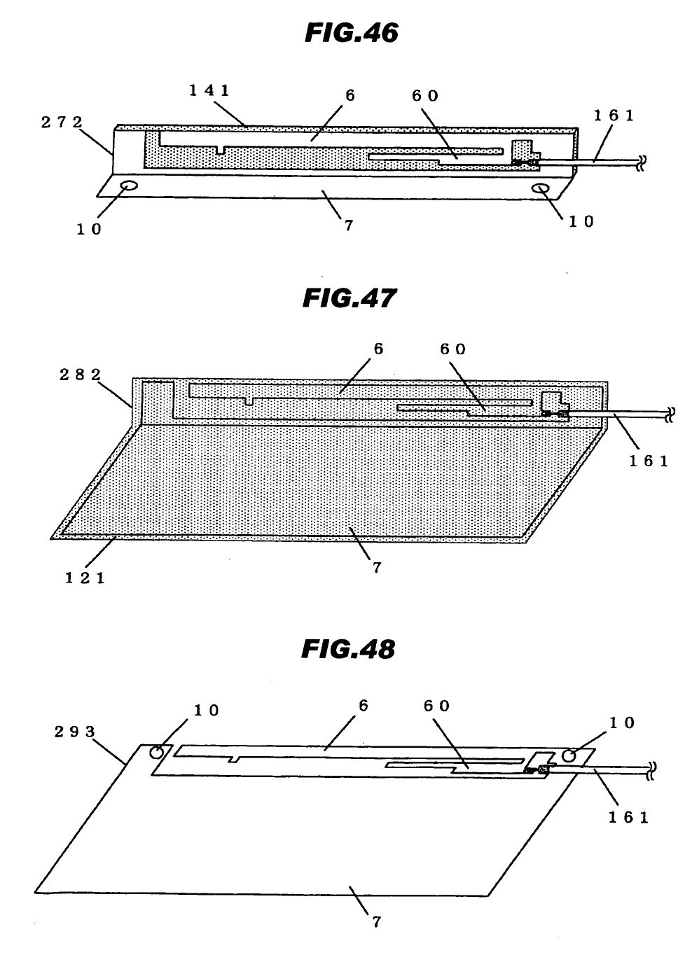

FIG. 46 shows an external appearance of a plate antenna 272, according to Embodiment 19 of the present invention, using the coaxial cable 161 as the feeder cable of the plate antenna 271 shown in FIG. 35.

FIG. 47 shows an external appearance of a plate antenna 282, according to Embodiment 20 of the present invention, using the coaxial cable 161 as the feeder cable of the plate antenna 281 shown in FIG. 36.

FIG. 48 shows an external appearance of a plate antenna 293, according to Embodiment 21 of the present invention, using the coaxial cable 161 as the feeder cable of the plate antenna 291 shown in FIG. 37.

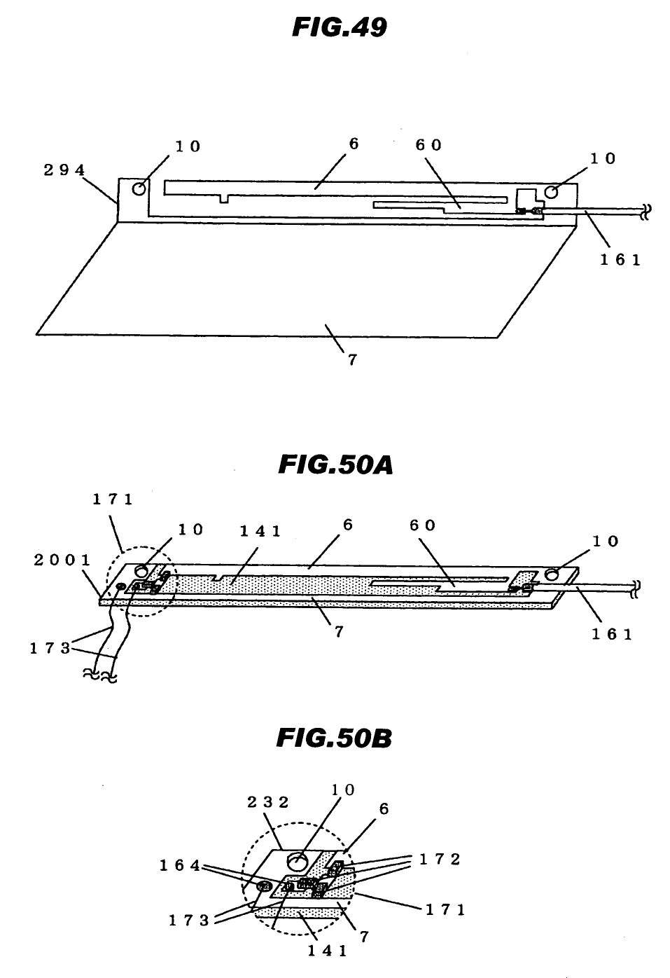

FIG. 49 shows an external appearance of a plate antenna 294, according to Embodiment 22 of the present invention, using the coaxial cable 161 as the feeder cable of the plate antenna 292 shown in FIG. 38.

Next, Embodiment 23 of the present invention will be described in detail with reference to FIGS. 50A and 50B.

FIG. 50A shows a plate antenna 2001 in which a tuning circuit 171 is installed on the plate antenna 202, using the dielectric substrate, shown in FIGS. 39A and 39B by using an open end of the large antenna element 6, and the ground 7 of the plate antenna 202, and a value of an supplied electric power to a variable capacitance diode used in the tuning circuit 171 is made variable, thereby making it possible to change an operating frequency. Also, FIG. 50B is an enlarged view of the tuning circuit 171 indicated by a dotted-line circle. As shown in FIG. 50B, the tuning circuit 171, as indicated by a dotted-line circle, is configured by disposing circuit components 172 such as a variable capacitance diode, a capacitor, and a resistor on parts of the ground 7 and the large antenna element 6, and a circuit pattern. The supply of the electric power to the variable capacitance diode is performed under the condition that the other ends of two thin single line cables 173 one ends of which are connected to respective portions by using solders 164 are electrically connected to a variable electric power source (not shown). It is noted that the circuit pattern of the tuning circuit 17 is changed and thus a dedicated connector or the like is used, and in this state, any other suitable cable such as a coaxial cable can be used instead of using the two thin single line cables 173 having one terminals connected to the respective portions by using the solders 164 shown in FIG. 50B.

A capacitance variable range for the supplied electric power to the variable capacitance diode used in the tuning circuit 171 installed on the plate antenna 2001 shown in FIGS. 50A and 50B is normally limited. For this reason, when the operating frequency of the antenna is changed by the tuning circuit, the tuning circuit must be configured by selecting the variable capacitance diode for which the capacitance change for the useable supplied electric power range is taken into consideration, and the various circuit components, and also the positions of the corresponding antenna element(s) and the ground to which the tuning circuit is connected must be selected so as to allow the entire frequency range to be changed to be covered. As a result of taking the distance or the like to the metallic frame 16 of the LCD main body 15 into consideration based on addition of the influences of the space and the electrical noises when the plate antenna 2001 is built in the LCD chassis 11, it is found out that in the plate antenna 2001, the vicinity of the open end of the large antenna element 6 is the position most suitable for installation of the tuning circuit 171 in the plate antenna 2001.

When the plate antenna 2001 is built in the LCD chassis 11 shown in FIG. 15, the built-in state in this case is the same as that shown in FIGS. 29A and 29B. At this time, in the case where the two thin single line cables 173 through which the electric power is supplied to the variable capacitance diode are passes to the back side of the LCD main body 15, and are connected to the variable electric power source (not shown) located in a position different from the built-in position of the plate antenna 2001, and the value of the supplied electric power to the variable capacitance diode is changed, thereby changing the operating frequency of the plate antenna 2001, the invasion of the electrical noises into the plate antenna 2001 can be sufficiently suppressed in the entire operating frequency band thus changed. As a result, it is possible to obtain the frequency gain characteristics for which the influence of the electrical noises is improved similarly to the case shown in FIGS. 20A and 20B, and thus it is possible to realize the built-in antenna in which the influence of the electrical noises is improved. It is noted that a position and a direction of distribution of the two thin single line cables 173 through which the electric power is supplied to the variable capacitance diode described above must be determined in consideration of the influence of the electrical noises existing within the LCD chassis 11. In the case of the plate antenna 2001, it is previously confirmed that even when the two thin single line cables 173 are distributed to the back side of the LCD main body 15, they are not influenced by the electrical noises. It is noted that in the case of the notebook-size PC 1 shown in FIG. 1, the two thin single line cables 173 through which the electric power is supplied to the variable capacitance diode described above may be passed through the hinge portion of the notebook-size PC 1 to be distributed from the LCD chassis 15 to the keyboard chassis 12.

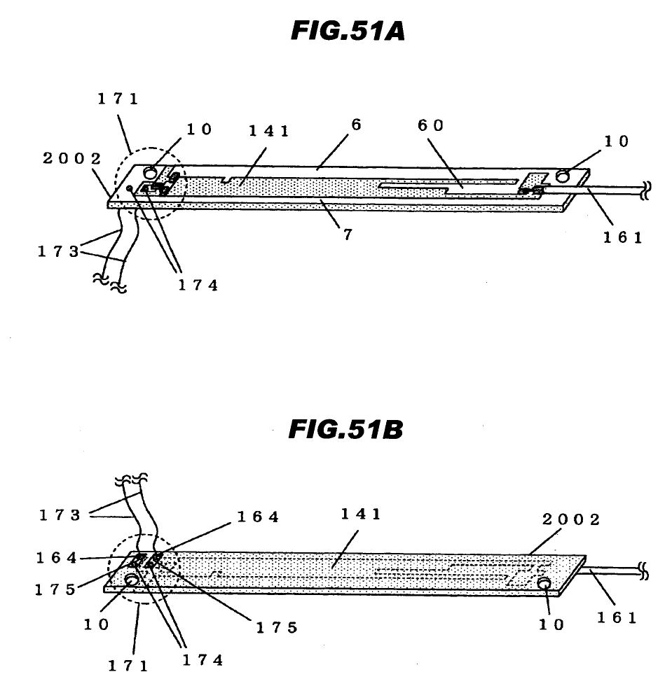

Next, Embodiment 24 of the present invention will be described in detail with reference to FIGS. 51A and 51B.

FIGS. 51A and 51B show a plate antenna 2002 in which the connection position of the two thin single line cables 173 through which the electric power is supplied to the tuning circuit installed on the plate antenna 2001 shown in FIGS. 50A and 50B is located on the back side of the dielectric substrate 141 via through holes 174. Also, FIG. 51A shows an external appearance of the plate antenna 2002 when viewed from the side (upper side) of the antenna elements 6 and 60 of the plate antenna 2002, and FIG. 51B shows an external appearance of the plate antenna 2002 when viewed from the back side on which the dielectric substrate 141 is formed. In FIG. 51A, a portion indicated by a dotted-line circle shows the tuning circuit portion when viewed from the upper side of the tuning circuit portion. Also, in FIG. 51B, a portion indicated by a dotted-line circle shows the tuning circuit portion when viewed from the back side of the tuning circuit portion. Referring now to FIGS. 51A and 51B, the two through holes 174 are formed in the positions in FIGS. 50A and 50B (on the upper side of the dielectric substrate 141) to which the two thin single line cables 173 are electrically connected, respectively, by using the solders 164. Also, the two through holes 174 are electrically connected to two conductive pads 175, respectively, on the back side having the dielectric substrate 141 formed thereon, and one ends of the two thin single line cable 173 are electrically connected to parts of the two conductive pads 175, respectively, by using the solders 164, and the other ends of the two thin single line cables 173 are electrically connected to the variable electric power source (not shown).

It is noted that a predetermined circuit pattern is formed in these conductive pads 175 and thus a dedicated connector or the like is used, thereby making it possible to replace the two thin single line cables 173 with any other suitable cable such as a coaxial cable.

The built-in state when the plate antenna 2002 is built in the LCD chassis 11 shown in FIG. 15 similarly to the case shown in FIGS. 50A and 50B is the same as that in the case shown in FIGS. 29A and 29B. Thus, when the value of the supplied electric power to the variable capacitance diode is changed, thereby changing the operating frequency of the plate antenna 2002, the invasion of the electrical noises into the plate antenna 2002 can be sufficiently suppressed in the entire operating frequency band thus changed. As a result, it is possible to obtain the frequency gain characteristics for which the influence of the electrical noises is improved similarly to the case shown in FIGS. 20A and 20B, and thus it is possible to realize the built-in antenna in which the influence of the electrical noises is improved. Note that, in this case as well, the two thin single line cables 173 through which the electric power is supplied to the variable capacitance diode are distributed to the back side of the LCD main body 15 in consideration of the influence of the electrical noises existing within the LCD chassis 11. Thus, it is previously confirmed that the two thin single line cables 173 are not influenced by the electrical noises

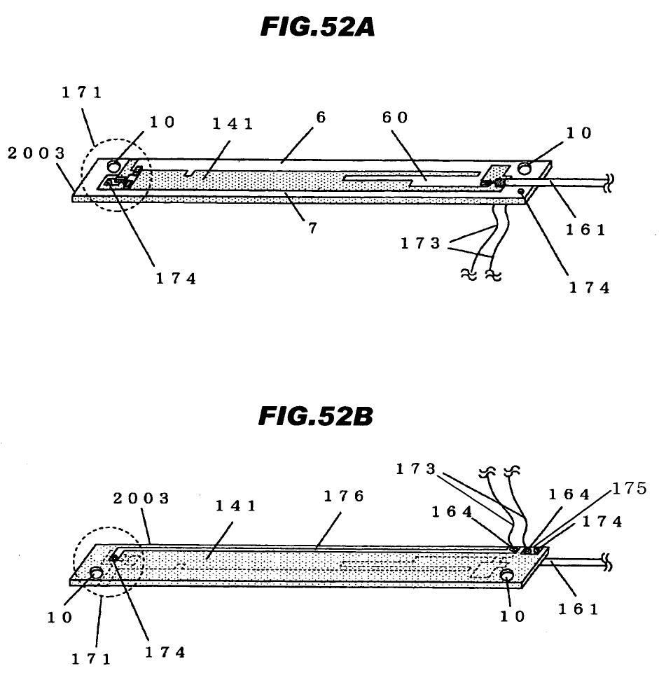

Next, Embodiment 25 of the present invention will be described with reference to FIGS. 52A and 52B.

FIGS. 52A and 52B show a plate antenna 2003 in which the connection position of the two thin single line cables 173 through which the electric power is supplied to the tuning circuit 171 installed on the plate antenna 2001 shown in FIGS. 50A and 50B is located on the back side having the dielectric substrate 141 formed thereon via the through holes 174 and a conductor line 176. Also, FIG. 52A shows an external appearance of the plate antenna 2003 when viewed from the side (upper side) of the antenna elements 6 and 60, and FIG. 52B shows an external appearance of the plate antenna 2002 when viewed from the back side having the dielectric substrate 141 formed thereon. Referring now to FIGS. 52A and 52B, one through hole 174 (left-hand side) is formed in the position (on the upper side opposite to the back side having the dielectric substrate 141 formed thereon) in FIGS. 50A and 50B to which one of the two thin single line cables 173 is electrically connected by using the solders 164. In addition, one end of the conductor line 176 provided on the back side having the dielectric substrate 141 formed thereon is electrically connected to the one through hole 174. Also, the other end (right-hand side) of the conductor line 176 is made to extend to the vicinity of the other through hole 174 to which the conductor pad 175 provided on the back side having the dielectric substrate 141 formed thereon is connected along a length direction of the dielectric substrate 141 so as to be opposite to the one end of the conductor line 176. In this case, as shown in FIG. 52A, the ground 7 of the plate antenna 2003 is formed in the length direction of the dielectric substrate 141 so as to extend from the left-hand side end to the right-hand side end of the dielectric substrate 141. Also, the other end of the conductor line 176 is disposed on the back side of the ground 7 of the plate antenna 2003. Also, the other ends of the two thin single line cables are electrically connected to parts of the conductor pad 175 and the other end of the conductor line 176, respectively, and the other ends of the two thin single line cables 173 are electrically connected to the variable electric power source (not shown). It is noted that a predetermined circuit pattern is formed in the conductor pad 175 and the other end of the conductor line 176 and thus a dedicated connector or the like is used, thereby making it possible to replace the two thin single line cables 173 with any other suitable cable such as a coaxial cable.

The built-in state when the plate antenna 2003 is built in the LCD chassis 11 shown in FIG. 15 similarly to the case shown in FIGS. 50A and 50B is the same as that in the case shown in FIGS. 29A and 29B. Thus, when the value of the supplied electric power to the variable capacitance diode is changed, thereby changing the operating frequency of the plate antenna 2003, the invasion of the electrical noises into the plate antenna 2003 can be sufficiently suppressed in the entire operating frequency band thus changed. As a result, it is possible to obtain the frequency gain characteristics for which the influence of the electrical noises is improved similarly to the case shown in FIGS. 20A and 20B, and thus it is possible to realize the built-in antenna in which the influence of the electrical noises is improved. Note that, in this case as well, the two thin single line cables 173 through which the electric power is supplied to the variable capacitance diode are distributed to the back side of the LCD main body 15 in consideration of the influence of the electrical noises existing within the LCD chassis 11. Thus, it is previously confirmed that the two thin single line cables 173 are not influenced by the electrical noises.

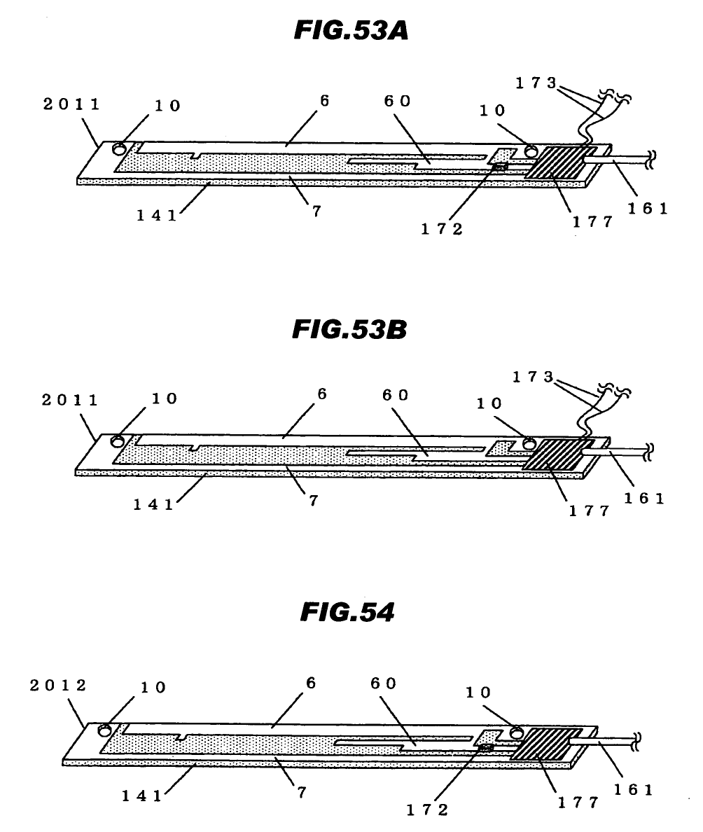

Next, Embodiment 26 of the present invention will be described with reference to FIGS. 53A and 53B.

FIG. 53A shows a plate antenna 2011 on which an amplification circuit 177 (its circuit configuration is not shown in the figure) holding the ground 7 in common with the plate antenna 231, using the dielectric substrate 141, shown in FIG. 28 is installed in the plate antenna 231. It is noted that when the amplification circuit 177 has no switching circuit for transmission and reception, the plate antenna 2011 is limited in use application to the reception antenna. In this case, it is assumed that the amplification circuit 177 has no switching circuit for transmission and reception. The amplification circuit 177 can be selected depending on the use purposes, the target specifications and the like of a low noise amplifier and the like. In each of FIGS. 53A and 53B, a coaxial cable 161 is electrically connected to an output terminal of the amplification circuit 177, a circuit element 172 is disposed in the feeding point, and each of the antenna elements 6 and 60 of the plate antenna 2011 is electrically connected to the amplification circuit 177. The frequency resonance characteristics of the plate antenna 2011 can not be confirmed in the presence of the coaxial cable 161 electrically connected to the amplification circuit 177. Thus, the circuit element 172 is eliminated, and in this state, the confirmation of the characteristics of the plate antenna 2011, the adjustment of the characteristics of connection between the plate antenna 2011 and the amplification circuit 177, and the like can be made easily in the position where the circuit element 172 is eliminated.

It is noted that when the circuit element 172 is composed of a resistor having a resistance value of 0 ohm, this state becomes equal to a state in which each of the antenna elements 6 and 60, and the amplification circuit 177 are directly connected to each other through a conductor as shown in FIG. 53B. In addition, when a single or a plurality of circuit elements 172 are provided, it is also possible to adjust the matching state between each of the antenna elements 6 and 60, and the application circuit 177. Also, one ends of the two thin single line cables 173 electrically connected to the amplification circuit 177 as used for supply of the operating electric power to the amplification circuit 177, and the other ends thereof are connected to a stabilized (variable) electric power source. It is noted that any other suitable cable such as a coaxial cable can be used for supply of the operating electric power to the amplification circuit 177.

It should be noted that the amplification circuit amplifies the strength of the signal transmitted or received from or at the antenna, and corrects the loss of the transmission line such as the cable through which the antenna and the transmission/reception tuner (module) are connected to each other. For this reason, the amplification circuit connects the transmission line connected to the feeding point as a signal input/output portion of the antenna, and the transmission line connected to the transmission/reception tuner (module) to each other irrespective of presence or absence of the switching circuit for transmission and reception. In the plate antenna 2011 shown in FIGS. 53A and 53B, the amplification circuit 177 is installed in the space of the ground 7 close to the feeding point. Also, the transmission line, on the circuit board, extending from the feeding point is electrically connected to one terminal of the amplification circuit 177, and the coaxial cable is electrically connected to the other terminal of the amplification circuit 177. In the case of the built-in antenna, the installation position of the amplification circuit needs to be selected in consideration of the space when the built-in antenna is built in the chassis, the loss of the transmission line, the influence of the electrical noises, and the like. Thus, in the plate antenna, the amplification circuit is installed in the position where the loss of the transmission line between the feeding point and the amplification circuit is suppressed, and the amplification circuit does not cause an obstruction during the building-in of the plate antenna.

When the plate antenna 2011 is built in the LCD chassis 11 shown in FIG. 15, the built-in state is the same as that in the case shown in FIGS. 29A and 29B. Thus, when the two thin single line cables 173 through which the electric power is supplied to the amplification circuit 177 is passed to the back side of the LCD main body 15, and are connected to the stabilized (variable) electric power source located in the position different from that where the plate antenna 2011 is built in the LCD chassis 11, the resulting frequency gain characteristics have no tendency to amplify the electrical noises themselves, and thus become the characteristics to which the effect of the amplification circuit 177 is added to the effect offered based on the frequency gain characteristics of FIGS. 20A and 20B. That is to say, this means that the invasion of the electrical noises into the antenna can be sufficiently suppressed. Thus, it is possible to realize the built-in antenna in which the influence of the electrical noises is improved. It is noted that a position and a direction of distribution of the two thin single line cables 173 through which the electric power is supplied to the variable capacitance diode described above must be determined in consideration of the influence of the electrical noises existing within the amplification circuit 177. In the case of the plate antenna 2011, it is previously confirmed that even when the two thin single line cables 173 are distributed to the back side of the LCD main body 15, they are not influenced by the electrical noises. It is noted that in the case of the notebook-size PC 1 shown in FIG. 1, the two thin single line cables 173 through which the electric power is supplied to the variable capacitance diode described above may be passed through the hinge portion of the notebook-size PC 1 to be distributed from the LCD chassis 15 to the keyboard chassis 12.

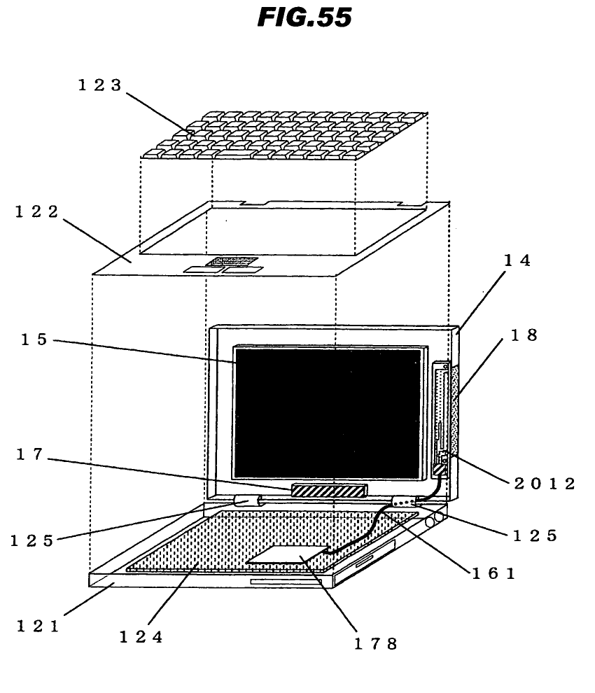

Next, Embodiment 27 of the present invention will be described in detail with reference to FIGS. 54 and 55.

FIG. 54 shows a plate antenna 2012 in which the supply of the operating electric power to the amplification circuit 177 (its circuit configuration is not illustrated in the figure) of the plate antenna 2011 shown in FIG. 53A is performed by superimposing the operating electric power for the amplification circuit 177 on the transmission signal which is transmitted through the coaxial cable electrically connected to the output terminal of the amplification circuit 177. In the antenna of the present invention, there is no problem when a general method is used as the method of superimposing the operating electric power for the amplification circuit 177 on the transmission signal which is transmitted through the coaxial cable. By adopting this construction, it is possible to remove the two thin single line cables 173 shown in FIGS. 53A and 53B.

FIG. 55 shows a state in which the plate antenna 2012 shown in FIG. 54 is built in the LCD chassis 11 shown in FIG. 15, and the other end of the coaxial cable 161 having one end connected to the output terminal of the amplification circuit 177 mounted to the plate antenna 2012 is electrically connected to the reception tuner (module) 178 installed on the motherboard 124 provided within the keyboard chassis 12. It is noted that the built-in state of the plate antenna 2012 is the same as that in the case of FIGS. 29A and 29B. A method of distributing the coaxial cable 161 shown in FIG. 54 is general one in the case of the notebook-size PC 1, and thus the coaxial cable 161 is passed through the hinge portion 125 through which the LCD chassis 11 and the keyboard chassis 12 are connected to each other. Moreover, the coaxial cable 161 having one end connected to the output terminal of the amplification circuit 177 is disposed so as to avoid the contact with the metallic frame 16 of the LCD main body 15 and the inverter circuit 17 in consideration of the influence of the electrical noises within the LCD chassis 11. In the case where the operating electric power for the amplification circuit 177 mounted to the plate antenna 2012 is superimposed on the transmission signal which is transmitted through the coaxial cable 161, a circuit configuration with which the operating electric power for the amplification circuit 177 can be superimposed on the transmission signal which is transmitted through the coaxial cable 161, and can be separated from the received signal received at the plate antenna 2012 is added to the reception tuner 178 shown in FIG. 55.

Even when the circuit configuration with which the operating electric power for the amplification circuit 177 is superimposed on the transmission signal which is transmitted through the coaxial cable 161, and is separated from the received signal received at the plate antenna 2012 is added to the reception tuner 178, the resulting frequency gain characteristics have no tendency to amplify the electrical noises themselves, and thus become the characteristics in which the effect of the amplification circuit 177 is added to the effect offered based on the frequency gain characteristics of FIGS. 20A and 20B. That is to say, this means that the invasion of the electrical noises into the antenna can be sufficiently suppressed. Thus, it is possible to realize the built-in antenna in which the influence of the electrical noises is improved.

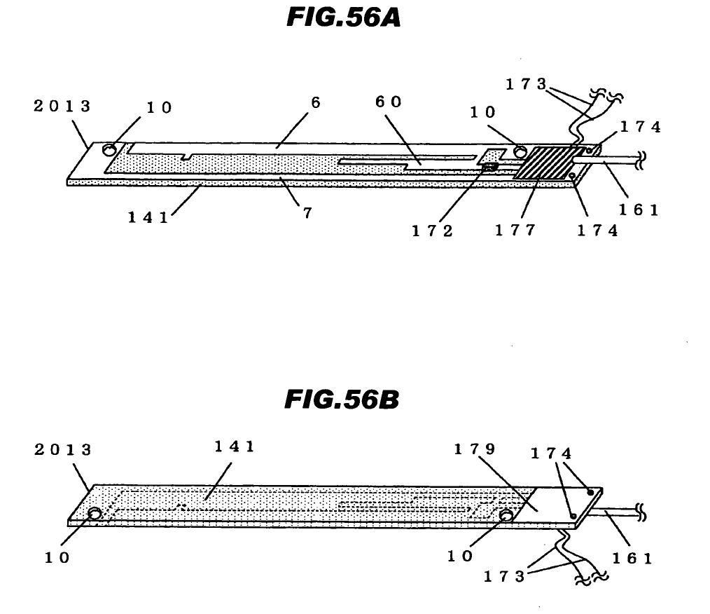

Next, Embodiment 28 of the present invention will be described with reference to FIGS. 56A and 56B.

FIGS. 56A and 56B show a plate antenna 2013 in which a ground 179 for an amplification circuit is provided on the back side of the amplification circuit 177 (its circuit configuration is not illustrated in the figures) mounted to the plate antenna 2011 shown in FIG. 53A by using through holes 174. With the plate antenna 2013 as well, the excellent characteristics are obtained in the same built-in state as that shown in FIG. 55, and thus it is possible to realize the built-in antenna in which the influence of the electrical noises is improved.

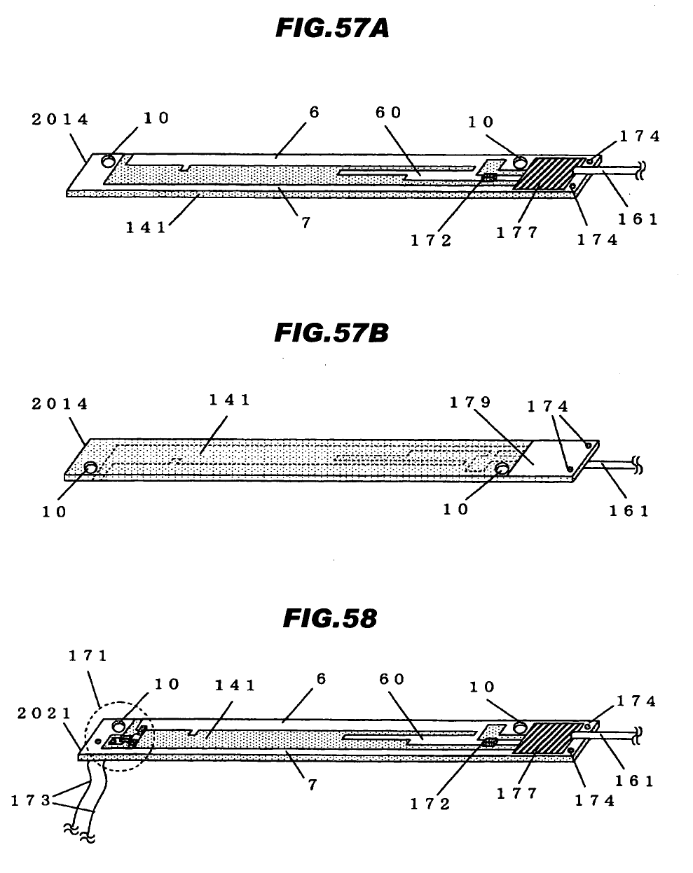

Next, Embodiment 29 of the present invention will be described with reference to FIGS. 57A and 57B.

FIGS. 57A and 57B show a plate antenna 2014 in which the ground 179 for an amplification circuit is provided on the back side of the amplification circuit 177 (its circuit configuration is not illustrated in the figures) mounted to the plate antenna 2012 shown in FIG. 54 by using the through holes 174. With the plate antenna 2014 as well, the excellent characteristics are obtained in the same built-in state as that shown in FIG. 55, and it is possible to realize the built-in antenna in which the influence of the electrical noises is improved.

Next, Embodiment 30 of the present invention will be described in detail with reference to FIG. 58.

FIG. 58 shows a plate antenna 2021 in which the tuning circuit 171 shown in FIGS. 51A and 51B is mounted in the plate antenna 2014 shown in FIGS. 57A and 57B in a position opposite in length direction to a position of the amplification circuit 177 mounted to the plate antenna 2014 to configure its circuit configuration (by using two through holes, two conductor pads, and the two thin single line cable 173). In this case, the plate antenna 2021 includes both the tuning circuit 171 and the amplification circuit 177. When the plate antenna 2021 is built in the LCD chassis 11 similarly to the case shown in FIG. 55, the two thin single line cable 173 through which the electric power is supplied to the variable capacitance diode are distributed to the back side of the LCD main body 15 similarly to the case of FIG. 50 in consideration of the influence of the electrical noises within the LCD chassis 11, and the value of the supplied electric power to the variable capacitance diode is changed, thereby changing the operating frequency of the plate antenna 2021, there is no tendency to amplify the electrical noises themselves in the entire operating frequency band thus changed, and the frequency gain characteristics are obtained in which the effect of the amplification circuit 177 is added to the effect offered based on the frequency gain characteristics shown in FIGS. 20A and 20B. As a result, in Embodiment 30 as well, it is possible to realize the built-in antenna in which the influence of the electrical noises is improved. Note that, when the plate antenna 2021 is built in the LCD chassis 11 similarly to the case shown in FIG. 55, the two thin single line cable 173 through which the electric power is supplied to the variable capacitance diode are distributed in consideration of the influence of the electrical noises within the chassis 11, thereby allowing the two thin single line cable 173 to be passed through the hinge portion 125 to be disposed within the keyboard chassis 12 similarly to the case of the coaxial cable 161 having one end connected to the output terminal of the amplification circuit 177.

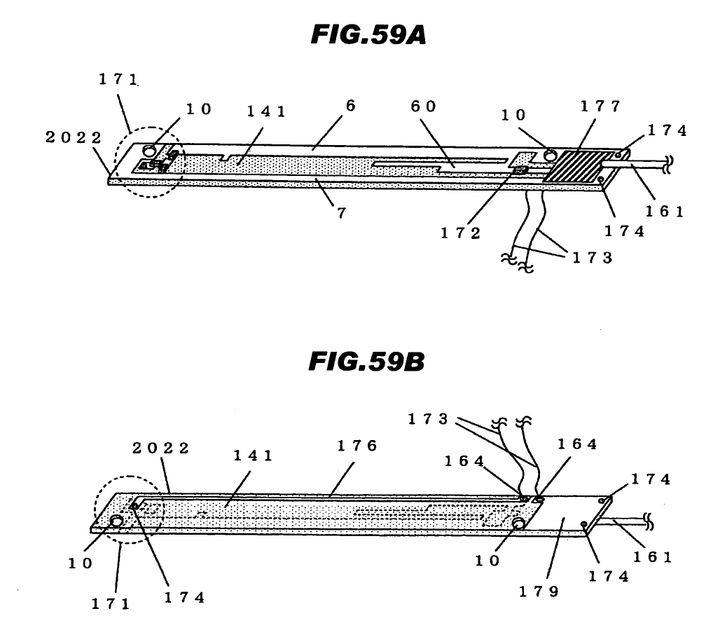

Next, Embodiment 31 of the present invention will be described in detail with reference to FIGS. 59A and 59B.

FIGS. 59A and 59B show a plate antenna 2022 in which the tuning circuit 171 shown in FIGS. 52A and 52B is mounted in the plate antenna 2014 shown in FIGS. 57A and 57B in a position opposite in length direction to a position of the amplification circuit 177 mounted to the plate antenna 2014 to configure its circuit configuration (by using one through hole and the conductor line 176). In this case, the plate antenna 2022 includes both the tuning circuit 171 and the amplification circuit 177. In FIG. 59B, the two thin single line cables 173 through which the electric power is supplied to the tuning circuit 171 are electrically connected to one end of the conductor line 176, and the ground 179 for an amplification circuit by using the solders 164, respectively. When the plate antenna 2022 is built in the LCD chassis 11 similarly to the case shown in FIG. 55, the two thin single line cable 173 through which the electric power is supplied to the variable capacitance diode are distributed to the back side of the LCD main body 15 similarly to the case of FIG. 50 in consideration of the influence of the electrical noises within the LCD chassis 11, and the value of the supplied electric power to the variable capacitance diode is changed, thereby changing the operating frequency of the plate antenna 2022, there is no tendency to amplify the electrical noises themselves in the entire operating frequency band thus changed, and the frequency gain characteristics are obtained in which the effects of the amplification circuit 177 is added to the effect offered based on the frequency gain characteristics shown in FIGS. 20A and 20B. As a result, in Embodiment 31 as well, it is possible to realize the built-in antenna in which the influence of the electrical noises is improved. Note that, when the plate antenna 2022 is built in the LCD chassis 11 similarly to the case shown in FIG. 55, the two thin single line cable 173 through which the electric power is supplied to the variable capacitance diode are distributed in consideration of the influence of the electrical noises within the chassis 11, thereby allowing the two thin single line cable 173 to be passed through the hinge portion 125 to be disposed within the keyboard chassis 12 similarly to the case of the coaxial cable 161 having one end connected to the output terminal of the amplification circuit 177.

In addition, in each of the plate antennas 2021 and 2022 shown in FIG. 58, and FIGS. 59A and 59B, respectively, even when the two thin single line cables as shown in FIGS. 53A and 53B are used instead of using the coaxial cable through which the transmission signal on which the operating electric power is superimposed is transmitted as the method of supplying the operating electric power to the amplification circuit 177, the excellent characteristics can be obtained similarly to the above case.

As set forth hereinabove, according to the present invention, in order to cope with the influence of the electrical noises generated from the electrical noise generating source existing in the chassis of the mobile terminal or the electrical apparatus are transmitted through the metallic (conductor) portion provided within the chassis, or propagated through the space to invade the antenna built in the chassis of the mobile terminal or the electrical apparatus, the design method made by taking it into consideration that the antenna elements and ground of the built-in antenna function independently of each other is used, the antenna structure in which the transmission paths of the electrical noises are largely reduced, and the method of building the antenna in the chassis are used, and the structure is used with which the invasion of the electrical noises due to the electromagnetic induction into the antenna is reduced. Therefore, the measures are taken to cope with the influence of the electrical noises with only the built-in antenna without making a change such as processing for the structure within the chassis of the mobile terminal or the electrical apparatus. As a result, it is possible to realize the built-in antenna in which the influence of the electrical noises is improved.

In addition, according to the present invention, since the antenna itself has the simple structure, the antenna of the present invention is readily fabricated. Thus, since the existing fabricating technique and equipment can be utilized, it is possible to provide the inexpensive built-in antenna which is excellent in productivity and is readily handled, and in which the influence of the electrical noises is improved.

Although the invention has been described with respect to the specific embodiments for complete and clear disclosure, the appended claims are not to be thus limited but are to be construed as employing all modifications and alternative constructions that may occur to one skilled in the art which fairly fall within the basic teaching herein set forth.

What is claimed is:

1. An antenna, comprising:
antenna elements;
an electric power feeding portion for supplying an electric power to each of the antenna elements;
a short-circuit element for antenna matching electrically connected to the electric power feeding portion; and
a ground connected to the short-circuit element,
wherein the antenna is built in a chassis made of a metal, and the chassis made of a metal and the ground are electrically connected to each other.

2. An antenna built in a chassis of a mobile terminal or an electrical apparatus, comprising:
a single or a plurality of antenna elements; and
a ground,
wherein the ground is electrically connected to a metallic (conductor) portion of the chassis.

3. An antenna built in a chassis of a mobile terminal or an electrical apparatus, comprising:
a plurality of antenna elements;
a antenna element portion having a loop structure; and
a ground,
wherein the ground is electrically connected to a metallic (conductor) portion of the chassis.

4. The antenna according to claim 1, wherein when the antenna is built in a chassis of a mobile terminal or an electrical apparatus, a ground of the antenna is provided to face a metallic (conductor) part(s) so as to be close the metallic (conductor) part(s) within the chassis.

5. The antenna according to claim 2, wherein at least one slot structure is provided between the single or plurality of antenna elements and the ground.

6. The antenna according to claim 1, wherein one slot structure and one loop structure are provided between the plurality of antenna elements and the ground of the antenna with a feeding point as a boundary, and the slot structure is larger in size than the loop structure.

7. The antenna according to claim 6, wherein when the antenna is built in the chassis of the mobile terminal or the electrical apparatus, the loop structure of the antenna is installed in a position located at a distance away from a metallic (conductor) part(s).

8. The antenna according to claim 5, wherein when the plurality of antenna elements are provided in the antenna, at least one antenna element is provided between one antenna element and the ground.

9. The antenna according to claim 4, wherein the ground of the antenna and at least one antenna element are disposed so as to face each other.

10. The antenna according to claim 7, wherein the loop structure included in the antenna does not include a portion of the ground facing the metallic (conductor) part(s) close thereto within the chassis.

11. The antenna according to claim 4, wherein the ground of the antenna, and the metallic (conductor) part(s) of the chassis are not electrically connected to each other.

12. An electrical apparatus having the antenna according to claim 4 built therein.
